(19) United States
(12) Patent Application Publication
(10) Pub. No.: US 2024/0428758 A1
(43) Pub. Date: Dec. 26, 2024

(54) METHODS, SYSTEMS AND COMPUTER PROGRAM PRODUCTS FOR PROVIDING GRAPHICAL USER INTERFACES FOR PRODUCING DIGITAL CONTENT

(71) Applicant: Soundtrap AB, Stockholm (SE)

(72) Inventors: Andreas Wahlström, Stockholm (SE); Nikhil S. Nair, Stockholm (SE); George E. Mills, Stockholm (SE); George Baldwin, Lewes (GB); Adam Sundqvist, Stockholm (SE); Pedro Mathias Nakibar, Stockholm (SE); Petrus Briland, Järfälla (SE); Johannes Bugiel, Füsse (DE); Song Li, London (GB)

(73) Assignee: Soundtrap AB, Stockholm (SE)

(21) Appl. No.: 18/340,098

(22) Filed: Jun. 23, 2023

(51) Int. Cl. G10H 1/00

(52) U.S. Cl. CPC G10H 1/0008; G10H 2220/106; G10H 2220/161

(57) ABSTRACT

Media content is electronically produced through the use of a graphical user interface, where a composition canvas area is presented. User input devices are used to select locations for one or more graphical elements, which represent media content such as tracks, instruments, or additional users, on the composition canvas area. The selection of a location identifies where the graphical element should be overlaid on the composition canvas. Based on the location of the graphical elements, at least a section of a digital composition is produced.

### TECHNICAL FIELD

Example aspects described herein relate generally to digital content production and more particularly to methods, systems and computer program products for providing graphical user interfaces for producing digital content.

### BACKGROUND

Musical composition is the process of making or forming a piece of music by combining the parts, or elements of music. Various compositional techniques have been developed over the years to memorialize a musical composition. Music notation, for example, is any system used to visually represent aurally perceived music played with musical instruments or sung by the human voice using written, printed, or otherwise-produced symbols, including notation for durations of absence of sound such as rests. A music score is a written form of a musical composition that illustrates parts for different instruments on, for example, separate staves on large pages using words and symbols.

Music composition has traditionally involved the use of sheet music, which requires a deep understanding of music theory and the ability to write music notation. Technology has provided new tools to assist artists with implementing their ideas. Notation software, for example, has allowed artists write sheet music involving multiple instruments. While notation software has made it easier for musicians to create sheet music involving multiple instruments, it still requires a significant amount of skill and training.

As another example, Digital Audio Workstations (DAWs), provide artists with applications for recording, composing, producing, and editing audio. Rather than requiring an artist to write or edit sheet music using music notation, a DAW enables the artist to edit prestored data containing song, sequence, track structures, tempo and time signature information. A commonly used protocol for recording and playing back components of music on DAWs is MIDI (Musical Instrument Digital Interface). A DAW can be used to edit, resequence, speed up, slow down, or adjust in numerous ways a MIDI composition without costly and time-consuming rerecording.

DAWs can offer different interface options, including mixer-based, waveform-based, and clip-based layouts, to suit the preferences and workflow of different users. In a mixer-based layout, the graphical user interface mimics a traditional mixing console. This type of mixer provides a bird's eye view of all the tracks in the project, and users can adjust levels, panning, and effects on each track by manipulating virtual faders, knobs, and other controls. In a waveform-based layout, users can view the waveform of individual audio clips on each track. In a typical waveform-based layout, users can cut, paste, and move clips, as well as adjust volume levels and apply effects to specific clips. In a clip-based layout, users work with loops or short audio clips that can be manipulated and arranged on a timeline. Users can adjust the timing, pitch, and other parameters of each clip, as well as apply effects to individual clips or the entire project.

Some DAWs use graphical user interfaces (GUIs) to enable users to arrange preexisting files on musical tracks in a musical arrangement. The GUI allows the user to manipulate the files on the tracks. In addition, the instruments are displayed by the DAW. For example, a user may create a musical arrangement with vocals on the first track, a guitar on the second track, and drums on a third track. By placing each instrument on a separate track, a user can manipulate a single track without affecting the other tracks. For example, a user can adjust a volume of the vocals, without affecting the guitar track or drums track.

Writing music, even with the assistance of notation software, is relatively complicated because an artist still is expected to have an understanding music theory and be able to explain an entire pitch range of human hearing and the relationship between the pitches with words and symbols (e.g., write sheet music). Many still would like to compose music even if they cannot read, much less write, a note of music. As with notation software, DAW user interfaces (UI), even those developed for beginners, are typically too complex for less-digitally experienced creators to operate. Moreover, a certain level of control over compositions may need to be incorporated into a DAW by the developer to ensure users can express themselves to feel ownership of their music.

Moreover, the content (e.g., music, video, etc.) that a person desires to create may be complex. This complexity further adds to the time and skill for a lone person to create a desire work. The effect of the issues above is that users struggle to create or are unsatisfied with their content creations.

### SUMMARY

The embodiments disclosed herein addresses the above-mentioned issues by providing a system, method and computer product for producing digital compositions using a simplified interface that does not require a deep understanding of music theory or the operation of DAW software. The system allows users to compose, edit and mix music compositions easily and efficiently while also providing a level of control and ownership over the compositions.

In one example embodiment, a method for electronically producing media content is provided. The method involves presenting, via a graphical user interface, a composition canvas area. The method also involves receiving, via one or more input devices, a location selection for each of one or more graphical elements, wherein each of the one or more graphical elements represents media content including any one of (i) a track, (ii) one or more instruments, or (iii) an additional user, and wherein the location selection identifies a location on the composition canvas area at which to overlay a respective one of the one or more graphical elements, and producing at least a section of a digital composition based on the location of the one or more graphical elements on the composition canvas area.

In an example embodiment producing at least the section of the digital composition further involves determining one or more parameter values for each of the one or more graphical elements based on the location of the one or more graphical elements and producing at least the section of the digital composition based at least in part on (i) the media content represented by each of the one or more graphical elements and (ii) the one or more parameter values.

Additionally, in still another example embodiment herein, the method further comprises receiving, via the one or more input devices, one or more parameter values associated with the one or more graphical elements, the one or more parameter values representing (i) a predetermined playing style, (ii) a timbre value corresponding to a predetermined style of music, (iii) a complexity value corresponding to a degree of complexity of at least the section of the digital composition, or (iv) any combination thereof, where producing at least the section of the digital composition includes: producing at least the section of the digital composition based at least in part on (i) the media content represented by each of the one or more graphical elements and (ii) the one or more parameter values.

According to another example embodiment, the degree of complexity corresponds to any one of (i) a predefined range of chord complexity, (ii) a predefined range of melodic complexity, (iii) a predefined range of chord-melody tension, (iv) a predetermined range of chord progression novelty, (v) a predetermined range of chord bass melody, (vi) a degree of instrumentational variety, (vi) a combination thereof.

Additionally, in still another example embodiment herein, the method further comprises obtaining, via the one or more input devices in association with a first user, a selection of one or more additional users and retrieving, via the one or more input devices, one or more media content items corresponding to the selection of one or more additional users. In this example embodiment producing at least the section of the digital composition is based, in part, on one or more of the media content items corresponding to the additional users. According to another aspect herein another embodiment, the method further comprises obtaining a list of the one or more additional users based on a listening history of the first user; and presenting, via the graphical user interface, one or more selectable graphical images each representing one of the one or more additional users.

According to another example embodiment, the method further comprises combining two or more composition canvas areas, thereby combining two or more sections of the digital composition; receiving, via the one or more input devices, a selection of a predetermined effect from a plurality of predetermined effects; and applying the predetermined effect to at least one of the two or more sections of the digital composition.

Additionally, in still another example embodiment herein, the method further comprises combining two or more composition canvas areas, thereby combining two or more sections of the digital composition; receiving, via the one or more input devices, a selection of a transition content item from a plurality of transition content items; and inserting the transition content item between two composition canvas areas of the two or more composition canvas areas.

According to still another example embodiment, receiving the location selection includes: receiving, via the one or more input devices, a position modification instruction to move a first graphical element of the one or more graphical elements from a first location on the composition canvas area to a second location on the composition canvas area; and producing at least a section of the digital composition includes: modifying the digital composition based on the position modification instruction. According to another aspect herein another embodiment, modifying at least the section of the digital composition based on the position modification, further includes modifying at least the section of the digital composition based on a positional relationship between the first graphical element and one or more other graphical elements on the composition canvas area.

In another embodiment, receiving the location selection includes: receiving, via the one or more input devices, a position modification instruction to move a first graphical element of the one or more graphical elements, where: when the position of a first graphical element is moved along an X-axis of the composition canvas area, a first set of composition parameter values change, and when the position of the first graphical element is moved along the Y-axis of the composition canvas area, a second set of composition parameter values change. In an example aspect of this embodiment, at least the section of the digital composition is produced, at least in part, based on one or more of the first set of composition parameter values or the second set of composition parameter values.

According to another embodiment, the method further comprises receiving, via the one or more input devices, a graphic element selection of a first graphical element from the one or more graphical elements on the composition canvas area, thereby causing a parameter prompt to be presented via the graphical user interface; receiving, via the one or more input devices, a parameter modification instruction causing a parameter value associated with the first graphical element to be modified, thereby generating a modified parameter value; and modifying at least the section of the digital composition based on the modified parameter value.

In one example embodiment herein, the method further comprises presenting, via the graphical user interface, a selectable toggle graphical element, which when selected causes graphical user interface to switch between presenting a digital audio workstation interface and the composition canvas. According to one example embodiment herein, the digital audio workstation interface presents any one or a combination of (i) a mixer-based layout, (ii) a waveform-based layout, and (iii) a clip-based layout.

In still another example embodiment, before receiving the location selection, presenting via the graphical user interface, at least one of the one or more of the graphical elements on the composition canvas.

In another example embodiment, the method further comprises receiving, via the one or more input devices, a graphical element selection of at least one of the one or more graphical elements; and in response to receiving the graphical element selection, overlaying the graphical elements on the composition canvas.

According to another example embodiment, a system for electronically producing media content is provided. The system comprises one or more processors, wherein the system is in communication with a graphical user interface and one or more input devices; and memory storing one or more programs configured to be executed by the one or more processors the one or more programs including instructions for: presenting, via a graphical user interface, a composition canvas area; receiving, via one or more input devices, a location selection for each of one or more graphical elements, wherein each of the one or more graphical elements represents media content including any one of (i) a track, (ii) one or more instruments, or (iii) an additional user, and wherein the location selection identifies a location on the composition canvas area at which to overlay a respective one of the one or more graphical elements; and producing at least a section of a digital composition based on the location of the one or more graphical elements on the composition canvas area.

In an example embodiment, the one or more programs further includes instructions for producing at least the section of the digital composition further comprises: determining one or more parameter values for each of the one or more graphical elements based on the location of the one or more graphical elements; and producing at least the section of the digital composition based at least in part on (i) the media content represented by each of the one or more graphical elements and (ii) the one or more parameter values.

Additionally, in still another example embodiment herein, the one or more programs further includes instructions for: receiving, via the one or more input devices, one or more parameter values associated with the one or more graphical elements, the one or more parameter values representing (i) a predetermined playing style, (ii) a timbre value corresponding to a predetermined style of music, (iii) a complexity value corresponding to a degree of complexity of the digital composition, or (iv) any combination thereof; and wherein producing at least the section of the digital composition includes: producing at least the section of the digital composition based at least in part on (i) the media content represented by each of the one or more graphical elements and (ii) the one or more parameter values.

In an example embodiment, the one or more programs further includes instructions for: wherein the degree of complexity corresponds to any one of (i) a predefined range of chord complexity, (ii) a predefined range of melodic complexity, (iii) a predefined range of chord-melody tension, (iv) a predetermined range of chord progression novelty, (v) a predetermined range of chord bass melody, (vi) a degree of instrumentational variety, (vi) a combination thereof.

In yet another example embodiment, the one or more programs further includes instructions for: receiving, via the one or more input devices in association with a first user, a selection of one or more additional users; retrieving, via the one or more input devices, one or more media content items corresponding to the selection of one or more additional users; and wherein producing at least the section of the digital composition is based, in part, on one or more of the media content items corresponding to the additional users.

According to another embodiment, the one or more programs further includes instructions for: obtaining a list of the one or more additional users based on a listening history of the first user; and presenting, via the graphical user interface, one or more selectable graphical images each representing one of the one or more additional users.

In an example embodiment, the one or more programs further includes instructions for: combining two or more composition canvas areas, thereby combining two or more sections of the digital composition; receiving, via the one or more input devices, a selection of a predetermined effect from a plurality of predetermined effects; and applying the predetermined effect to at least one of the two or more sections of the digital composition.

According to still another embodiment, the one or more programs further includes instructions for: combining two or more composition canvas areas, thereby combining two or more sections of the digital composition; receiving, via the one or more input devices, a selection of a transition content item from a plurality of transition content items; and inserting the transition content item between two composition canvas areas of the two or more composition canvas areas.

In an example embodiment, receiving the location selection includes: receiving, via the one or more input devices, a position modification instruction to move a first graphical element of the one or more graphical elements from a first location on the composition canvas area to a second location on the composition canvas area; and wherein producing at least a section of the digital composition includes: modifying at least the section of the digital composition based on the position modification instruction.

In one an example embodiment, modifying at least the section of the digital composition based on the position modification, further includes modifying at least the section of the digital composition based on a positional relationship between the first graphical element and one or more other graphical elements on the composition canvas area.

In still another embodiment, receiving the location selection includes: receiving, via the one or more input devices, a position modification instruction to move a first graphical element of the one or more graphical elements, wherein: when the position of a first graphical element is moved along an X-axis of the composition canvas area, a first set of composition parameter values change, and when the position of the first graphical element is moved along the Y-axis of the composition canvas area, a second set of composition parameter values change; and wherein at least the section of the digital composition is produced, at least in part, based on one or more of the first set of composition parameter values or the second set of composition parameter values.

In still a further embodiment, the one or more programs further includes instructions for: receiving, via the one or more input devices, a graphic element selection of a first graphical element from the one or more graphical elements on the composition canvas area, thereby causing a parameter prompt to be presented via the graphical user interface; receiving, via the one or more input devices, a parameter modification instruction causing a parameter value associated with the first graphical element to be modified, thereby generating a modified parameter value; and modifying at least the section of the digital composition based on the modified parameter value.

In an example embodiment, the one or more programs further includes instructions for: presenting, via the graphical user interface, a selectable toggle graphical element, which when selected causes graphical user interface to switch between presenting a digital audio workstation interface and the composition canvas.

In a further embodiment, the digital audio workstation interface presents any one or a combination of (i) a mixer-based layout, (ii) a waveform-based layout, and (iii) a clip-based layout.

In yet another embodiment, the one or more programs further includes instructions for: before receiving the location selection, presenting via the graphical user interface, at least one of the one or more of the graphical elements on the composition canvas.

In another embodiment, the one or more programs further includes instructions for: receiving, via the one or more input devices, a graphical element selection of at least one of the one or more graphical elements; and in response to receiving the graphical element selection, overlaying the graphical elements on the composition canvas.

In yet another embodiment herein, there is provided a non-transitory computer-readable storage medium storing one or more programs configured to be executed by one or more processors of a computer system that is in communication with a graphical user interface and one or more input devices, the one or more programs including instructions for performing the methods described herein. In an example embodiment, the instructions cause the one or more processors to perform: presenting, via a graphical user interface, a composition canvas area; receiving, via one or more input devices, a location selection for each of one or more graphical elements, wherein each of the one or more graphical elements represents media content including any one of (i) a track, (ii) one or more instruments, or (iii) an additional user, and wherein the location selection identifies a location on the composition canvas area at which to overlay a respective one of the one or more graphical elements; and producing at least a section of a digital composition based on the location of the one or more graphical elements on the composition canvas area.

### BRIEF DESCRIPTION OF DRAWINGS

The features and advantages of the example embodiments of the invention presented herein will become more apparent from the detailed description set forth below when taken in conjunction with the following drawings.

FIG. 1 illustrates a method for electronically producing media content, according to an example embodiment.

FIG. 2A illustrates an unpopulated composition canvas area presented via a graphical user interface of a computing device for electronically producing media content, according to an example embodiment.

FIG. 2B illustrates a composition canvas area of FIG. 2A being populated with graphical elements using an input device, according to an example embodiment.

FIG. 2C illustrates a list of selectable graphical elements from which a user can select to designate a type of graphical element, in accordance with an example embodiment.

FIG. 2D illustrates how a graphical element that has been selected can be modified, according to an example embodiment.

FIG. 2E particularly illustrates a composition canvas area where the graphical element has been changed from one type of instrument to another type of instrument, according to an example embodiment.

FIG. 2F illustrates a composition canvas area on which various graphical elements, have been overlayed on a composition canvas area, according to an example embodiment.

FIG. 2G illustrates a composition canvas area on which a user has modified the parameter values associated with graphical elements, according to an example embodiment.

FIG. 3 illustrates a composition canvas area having a toggle that can be selected to switch between presenting a digital audio workstation (DAW) interface and the composition canvas area interface, according to an example embodiment.

FIG. 4 represents an example digital audio workstation (DAW) interface, according to an example embodiment.

FIG. 5A illustrates a composition canvas area presented via a graphical user interface of a computing device for electronically producing media content, according to an example embodiment.

FIG. 5B illustrates an example canvas composition area being populated with a graphical element where a prearranged digital composition has been preloaded, according to an example embodiment.

FIG. 5C illustrates a composition canvas area being populated with one or more graphical elements using an input device, according to an example embodiment.

FIG. 6 illustrates a graphical user interface that provides selectable effects graphical elements for adding effects and variety to one or more composition canvas areas of a digital composition, according to an example embodiment.

FIG. 7A illustrates an example graphical user interface for navigating between different composition canvas areas corresponding to sections of a digital composition, according to an example embodiment.

FIG. 7B illustrates an example graphical user interface for navigating between different composition canvas areas corresponding to sections of a digital composition, according to an example embodiment.

FIG. 7C illustrates a method for adding transitions between digital composition sections, according to an example embodiment.

FIG. 8 is a block diagram of a system for providing graphical user interfaces for producing digital content according to the example embodiments described herein.

### DESCRIPTION

A “canvas” or “composition canvas area” as used herein means the portion of a graphical user interface on which one or more graphical elements can be overlayed.

A “composition structure” or “song structure” as used herein is a section of a composition involving chorus, pre-chorus, verse, bridge, and other similar parts. Digitized composition structures are the different parts of a composition that are arranged in a specific order to create a digital composition (e.g., a digital song composition). Each section can have its own unique characteristics in terms of melody, rhythm, and lyrics, and they work together to create a cohesive musical experience.

A “digital composition” as used herein is a work (e.g., musical work) that has been produced using digital technology. This can include software synthesizers, digital audio workstations (DAWs), virtual instruments, and other digital tools that allow composers to create and manipulate sounds and music in a computer environment.

A “content composition system” as used herein is any now known or future developed application and/or hardware that uses algorithms and/or rules to produce digital composition(s) in real-time, with or without the need for human intervention. The process can involve a variety of techniques and approaches, depending on the specific content composition system and its programming.

One non-limiting technique that can be used by the content composition system is to apply parameters in a predictable manner e.g., using a rule-based method. For example, the content composition system could apply parameters such as a particular tempo, volume or the like for a given instrument. Additionally, or alternatively, the content composition system can use e.g., of probabilistic models to produce melodies, harmonies, and rhythms. These models use probability distributions to determine the likelihood of certain notes, chords or rhythms being played at any given time, based on the patterns and structures of the digital composition being produced. Yet another approach can involve the use of artificial neural networks, which can be trained to learn audio patterns and produce new compositions based on those patterns. Neural networks can also be used to create a digital composition that responds to external inputs, such as changes in tempo or mood. Content composition systems may also apply various parameter values into their algorithms, allowing for variations in the digital composition being produced.

This results in compositions can be completely unique and never repeated in exactly the same way. For example, a content composition system according to the embodiments described herein may also incorporate random elements into their algorithms, allowing for unexpected and unpredictable variations in the digital composition being produced. This also can result in compositions that are completely unique and never repeated in exactly the same way. In yet other embodiments, the above content compositions systems can use techniques that result in compositions that are not necessarily unique and might be repeated in the same or substantially the same way.

In an example implementation, a content composition system is trained to modify a prearranged digital composition (e.g., composed by a user of a DAW). The training of the content composition system can be performed by analyzing and learning the patterns, structures, and features in e.g., audio data representing the prearranged digital composition. In some example embodiments, once the content composition system has analyzed the audio data and learned from it, the system can then use this knowledge to produce digital compositions that are based on the prearranged digital composition, but with variations and modifications that make them unique. The content composition system may be programmed, for example, to introduce new melodies, harmonies, rhythms, or other musical elements based on the patterns and structures it has learned, creating a digital composition that may be e.g., similar to the prearranged digital composition but with its own distinct variations.

In some embodiments, the content composition system provides user interface functionality that can be leveraged for all types of compositional adjustments, whether or not the system leverages any rule-based approaches, probabilistic models, neural networks, or the like.

An “instrument” as used herein is any device that can produce sound, either by mechanical means, through electronic or digital processes, or through vocalization (i.e., vocals). This broad definition includes traditional acoustic instruments such as pianos, guitars, and drums, as well as electronic instruments such as synthesizers and drum machines. It also includes devices that produce sounds through physical manipulation, such as wind and brass instruments, and instruments that create sounds through vocalization, such as the human voice. In addition to physical and vocal instruments, the definition of instrument also includes software and digital tools that can be used to create and manipulate sound. These tools include digital audio workstations (DAWs), software synthesizers, and virtual instruments, which allow composers and producers to create music using computer software.

A “composition structure” or “song structure” as used herein is a section of a composition involving chorus, pre-chorus, verse, bridge, and other similar parts. Composition structures are the different parts of a composition that are arranged in a specific order to create a digital composition (e.g., a digital song composition). Each section can have its own unique characteristics in terms of melody, rhythm, and lyrics, and they work together to create a cohesive musical experience.

A “graphical element” as used herein is a visual component or object that is displayed on a computer screen or other output device. Graphical elements can include images, icons, text, lines, shapes, charts, graphs, pictograms and ideograms among others. A graphical element can be used to create at least a portion of a user interface (UI) or to display information in a visually appealing and easy-to-understand format. Each graphical element serves as a link or shortcut to access a content creation application or data. In some embodiments, libraries or frameworks that include pre-built functions for drawing or rendering graphics are used to provide the graphical elements. These libraries may also provide functions for handling user input or events, such as touch events, mouse clicks, keyboard presses, or voice commands, that interact with the graphical elements on the screen. When a user touches the screen with their finger, for example, the touch is detected by the device's touch screen sensor, which sends a signal to the operating system (OS) of the device. The OS then generates a touch event, which includes information about the location of the touch, and other relevant details. The touch event is, in turn, passed to the application or program that is currently running on the computing device, which are, for example, the method and operations of the computer program products executed by one or more processors according to the embodiments described herein. In turn, the information passed to the application or program is used to determine which graphical element was touched, and to perform an appropriate action in response to the touch.

For example, a graphical element representing an instrument can be in the shape of a bubble or a shape representing a particular instrument or another user. Each graphical element serves as a link or shortcut to access a content creation application or data. If a user touches the bubble or other shape representing the particular instrument, track or the other user, the application can use the touch event to trigger an action, such as modify parameters associated with generating a digital composition or modifying an existing digital composition accordingly. A graphical element can correspond to one or more tracks of a digital composition.

“Produce” and “producing” as used herein in the context of media content, generally refer to creating, modifying, or processing of a digital composition. This can include composing, arranging, recording, mixing, and mastering one or more media content items.

A “track” as used herein is a single piece of recorded media content. A track can correspond to an entire composition (e.g., an entire song), a section of a composition, or a discrete component such as an outro track, click track, backing track, rhythm track, scratch track, etc.

A “transition” as used herein is a musical passage that is between two sections of a digital composition (e.g., a song) for the purpose of connecting one section of the digital composition to another. Transitions can be used, for example, to create a sense of flow and continuity in a song, and they can take many forms. Some common types of transitions in music include: drum fills: a drum fill is a short solo played by the drummer that leads into the next section of a song; arpeggios or riffs: an arpeggio or riff is a repeating musical pattern that is played to create a sense of anticipation and lead into the next section of the song; chord progressions: a chord progression is a sequence of chords that is played to create a sense of movement and tension that leads into the next section of the song; breakdowns: a breakdown is a section of a song where the instrumentation is stripped down to create a more sparse and minimal sound, which can be used to build tension before transitioning to the next section of the song. Other now known or future developed types of transitions are contemplated in the embodiments described herein.

Generally, the systems, methods and computer program products described herein provide a graphical user interface and mechanisms for presenting a composition canvas area that allow a user to select and manipulate graphical elements representing instruments. A digital composition, in some embodiments, is produced based on the type of graphical element(s) on the composition canvas area and their locations, as well as any global parameter values that are set.

In some embodiments, a digital composition, including any corresponding graphical elements and preset locations, is pre-arranged. This enables a user the ability to modify the pre-arranged digital composition, for example, by one or more of selecting, adding or moving graphical elements within the canvas area, or modifying any preset parameters, rather than starting from scratch.

The method also allows for setting parameter values for individual graphical elements, a set of graphical elements, a composition canvas area independent of any particular graphical element within the composition canvas area, or multiple composition canvas areas.

The parameter values corresponding to the graphical elements (whether individual graphical elements, a set of graphical elements or one or more composition canvas areas) are applied to a content composition system to produce (i.e., create or modify) the digital composition. In an example embodiment, the digital composition is comprised of one or more tracks. Each track, for example, can be a container that holds audio or MIDI data. MIDI stands for “Musical Instrument Digital Interface” and MIDI data refers to the digital messages used to control and communicate with electronic musical instruments, computers, and other digital devices. MIDI data can be used to trigger sounds on, to control the parameters applied to, or to input notes into, the content composition system or a digital audio workstation (DAW). MIDI data typically consists of a series of commands that are transmitted between devices and can include information such as note on/off messages, pitch bend, velocity, modulation, and control change messages.

Additionally, the embodiments described herein provide additional features, such as enabling one or more additional users who have permissioned to be modeled and associated with corresponding graphical elements. An additional user (e.g., second user, third user, etc.), in some embodiments, corresponds to one or more instruments. As such, the additional user can be associated with a particular graphical element (e.g., pianist, guitarist, percussionist, drummer, bass player, etc.). Further, the additional user can also correspond to one or more tracks.

While the example graphical elements depicted herein are in the shape of a bubble or a shape representing a particular instrument or additional user, other shapes of graphical elements can be used and still be within the scope of the embodiments described herein.

An ensemble of instruments represented by the graphical elements on the composition canvas area affects the digital composition. The parameter values associated with a graphical element can be one or more of added, selected, modified or manipulated by a user (e.g., using a mouse, pointer, touch (e.g., finger), voice command, etc.). Manipulating the graphical element by, for example, moving it in relation to its current position on the composition canvas area, or moving it in relation to other graphical elements on the composition canvas area provides further information that is translated into parameter values that are, in turn, applied to a content composition system and used to create the digital composition (e.g., media content such as music, video, etc.) or modify a pre-existing digital composition.

The graphical element themselves can be manually configured by the user. For example, an instrument a graphical element is based on (e.g., a pianist symbol) causes the content composition system to play a piano. The graphical elements can each have numerous parameter values. A graphical element representing a piano, for example, can have parameter values identifying the piano as a grand piano, an upright piano, or an electronic piano. A user need not be concerned with entering or selecting particular parameter values but can instead select a graphical element that has been preset with corresponding parameter values.

Several graphical elements can be added to the composition canvas area to create an entire digital composition, such as a complete set of tracks. Similarly, the graphical elements can be utilized to create a section of a composition, such as one or more tracks corresponding to a song section. The entire digital composition or section of a digital composition can comprise, for example, multiple melodic, harmonic, rhythmic compositions using various instruments and presets.

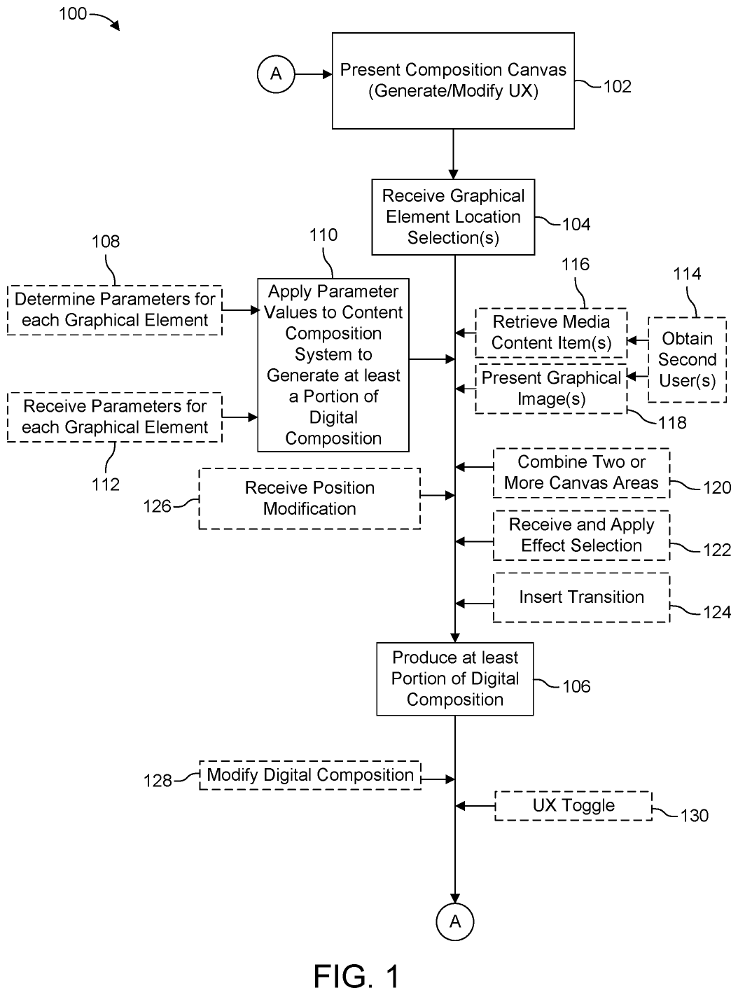

FIG. 1 illustrates a method for electronically producing media content 100 according to an example embodiment. The method corresponds to instructions that can be stored on non-transitory computer-readable memory which, when executed by a computing device having one or more processors, cause the one or more processors to perform the operations described therein.

In some embodiments, the method involves a composition canvas presentation operation 102, a graphical element location selection operation 104, and a digital composition production operation 106.

The composition canvas presentation operation 102 performs presenting, via a graphical user interface, a composition canvas area. In an example implementation, the composition canvas area is generated by a display subsystem of a computer that is responsible for rendering graphics and text on a screen, and may consist of a combination of hardware and software components. In an example implementation, the hardware components include a graphics card or an integrated graphics processor, which is responsible for generating the visual output that is sent to the display. The software components, in some embodiments, include device drivers and operating system components that enable the aspects of the methods described herein to communicate with the display subsystem and generate the graphics and text that appear on the screen.

In some embodiments, to create a composition canvas area on a graphical user interface, the method includes communicating with the display subsystem to allocate a region of a screen. This may involve setting up a window or other graphical container, defining the size and position of the canvas area, and specifying any other visual properties such as background color. Once the canvas area is created, the method uses the other operations described herein to generate the desired graphics and text within that area.

In some embodiments, the graphical element location selection operation 104 performs receiving, via one or more input devices, a graphical element location selection for each of one or more graphical elements. In an example implementation, each of the one or more graphical elements represents media content includes any one of (i) a track, (ii) one or more instruments, or (iii) an additional user (e.g., a first additional user, a second additional user, etc.). The graphical element location selection identifies a location on the composition canvas area at which to overlay a respective one of the one or more graphical elements.

In an example implementation, a user selects a graphical element on a computing device using the one or more input devices. The one or more input devices can be, for example a mouse, touchpad touchscreen, or voice control. The computing device receives the input from the input device and registers the selection of the graphical element. In turn, the user selects a location for the graphical element that has been selected using the same (or different) input device. The computing device receives the input from the input device and registers the new location of the graphical element.

In an example implementation, graphical element location selection operation 104 involves a combination of hardware and software components. For example, a mouse or touchscreen operates to send signals to an input subsystem of a device, which may be handled by a device driver or other low-level software component. This input data may then be passed to the operating system or application software for further processing. Once the input data has been received, one or more processors determine the location of the graphical element that has been selected. This may involve comparing the input data to a stored representation of the graphical user interface (GUI), such as a map of the screen with coordinates for each graphical element. Alternatively, the GUI may have an active programming interface that allows applications to register callbacks for mouse and keyboard events. Using this information, the device can determine which graphical element has been selected, and then perform any necessary actions in response to that selection, such as highlighting the element, launching a new window or menu, or executing a command associated with that element.

In some embodiments, digital composition production operation 106 performs producing at least a section of a digital composition based on the location of the one or more graphical elements on the composition canvas area. The above-described features and additional features depicted in FIG. 1 will be described below together with practical applications of the method.

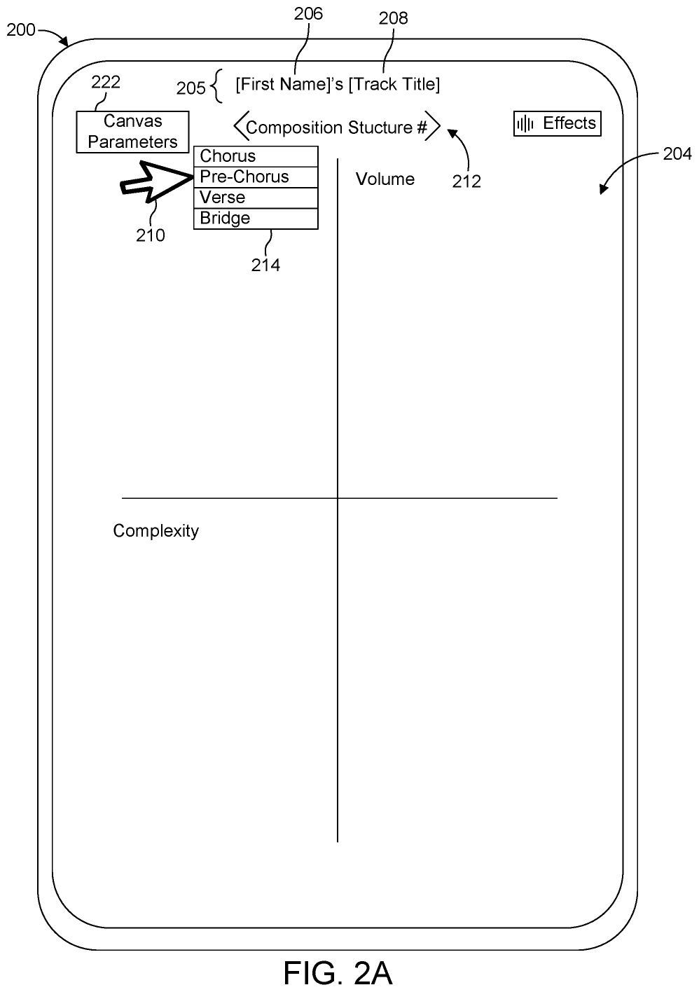

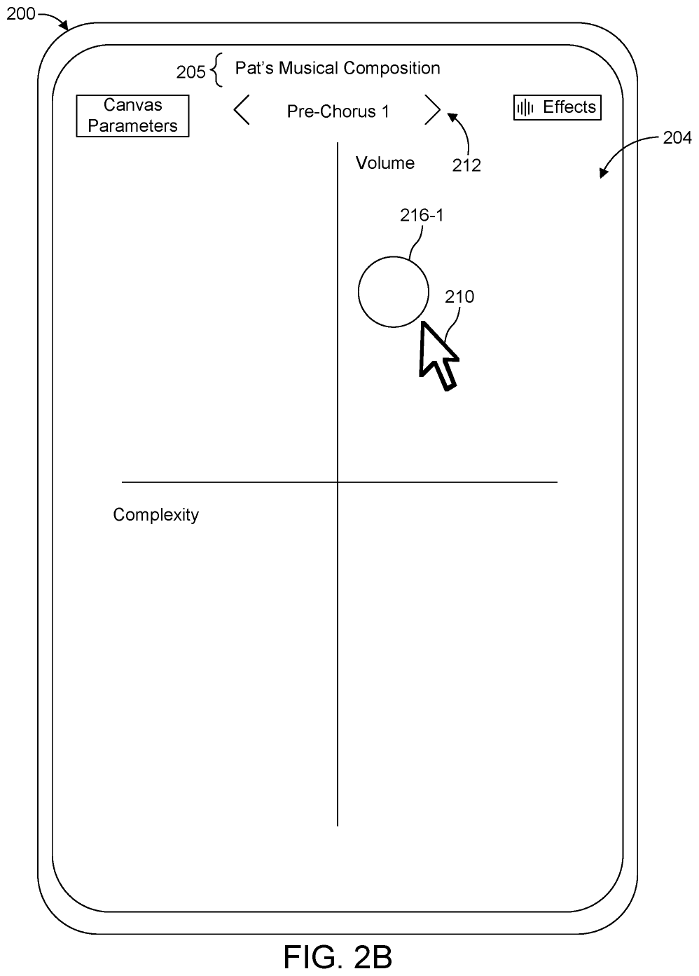

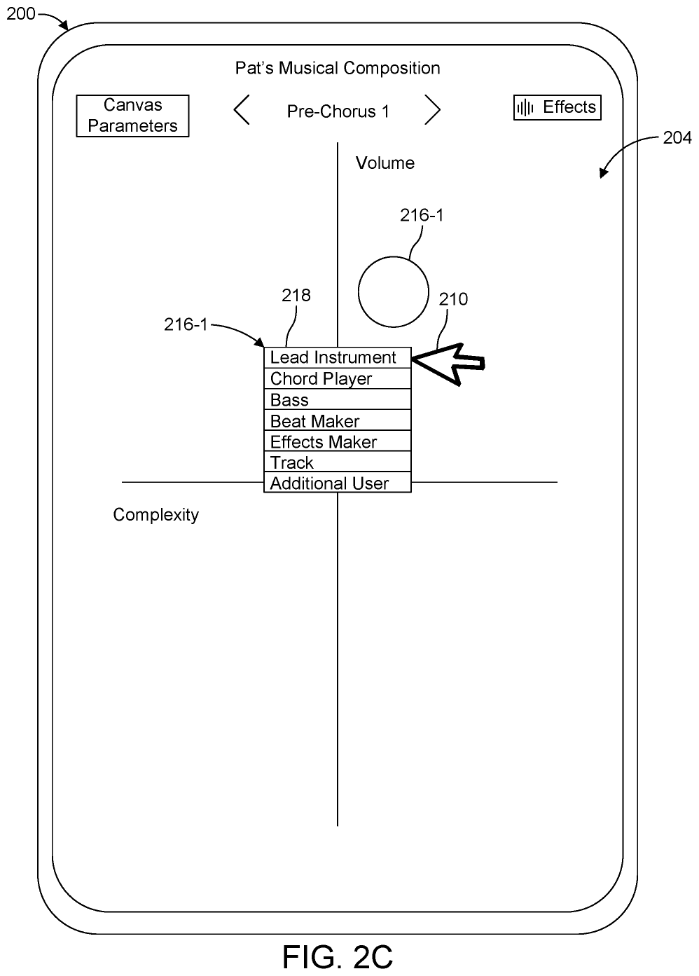

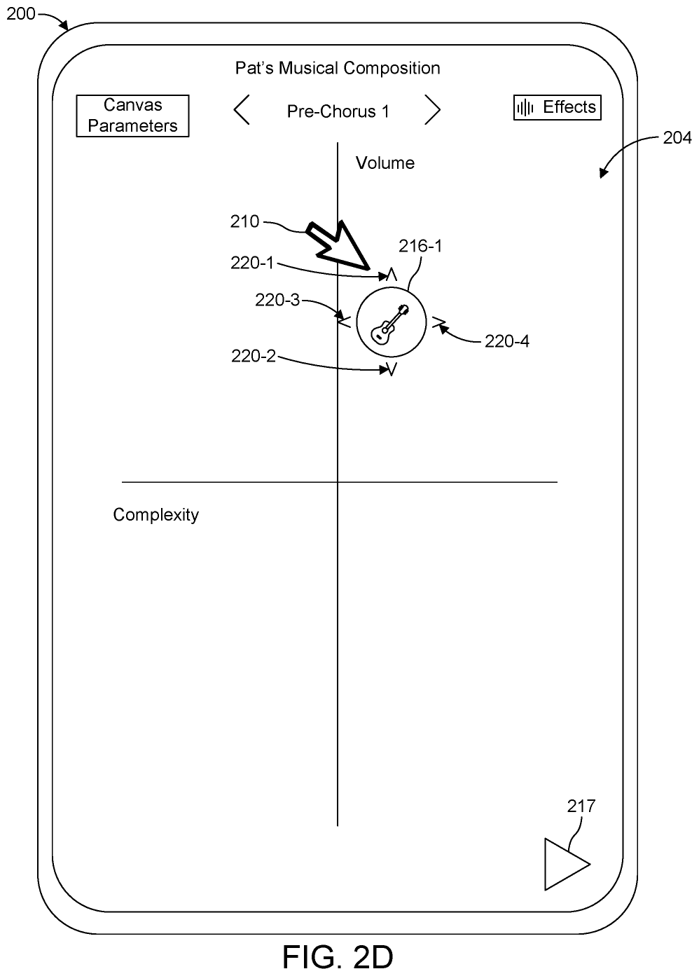

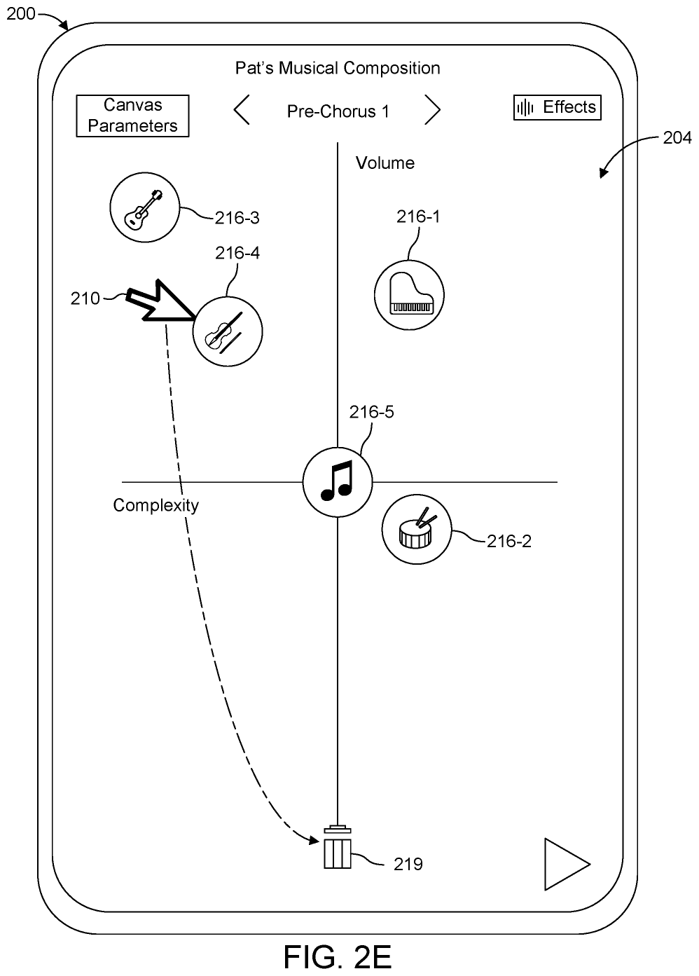

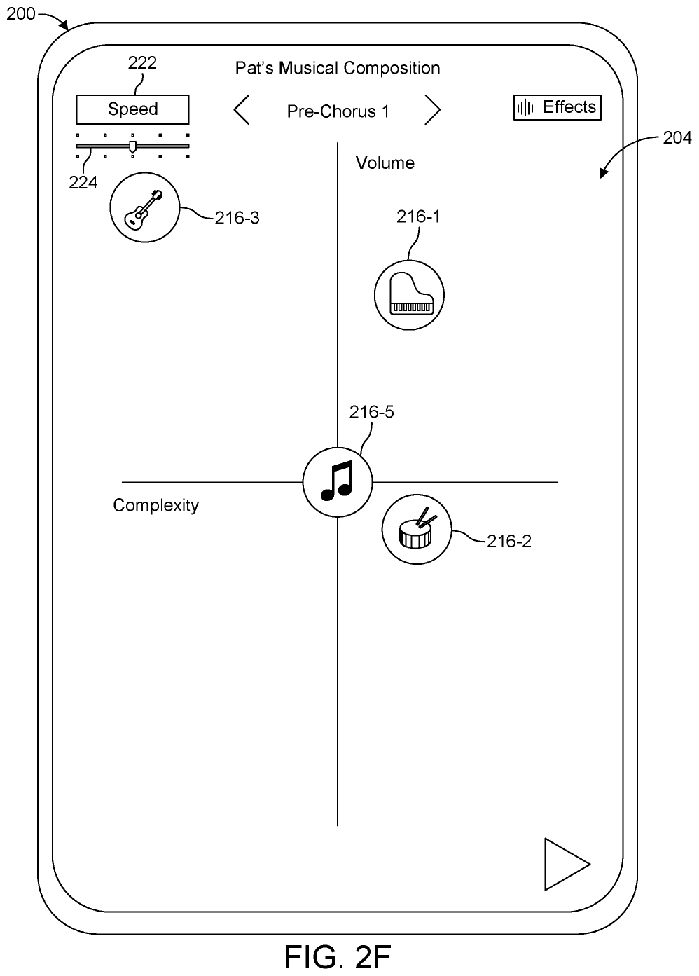

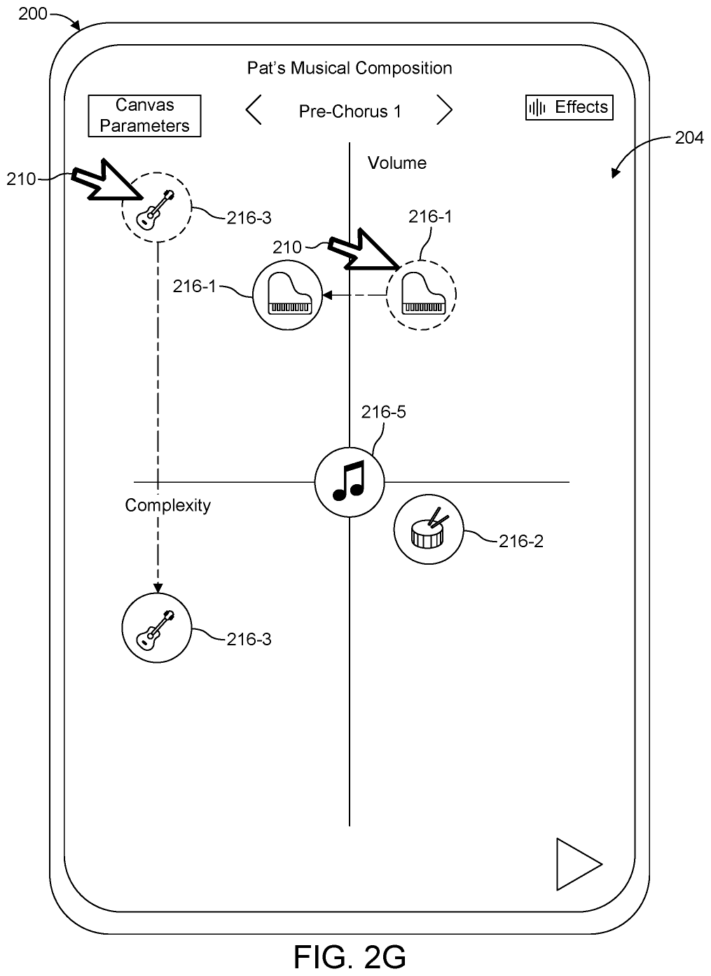

FIG. 2A illustrates an unpopulated composition canvas area 204 presented via a graphical user interface of a computing device 200 for electronically producing media content, according to an example embodiment. As shown in FIG. 2A, on the composition canvas area 204 is presented a composition title 205 for a digital composition. In the example implementation depicted in FIG. 2A, the title 205 is formed by the combination of a user's first name 206 and a track title 208. It should be understood that any naming convention for the title 205 can be implemented and still be within the scope of the example embodiment. As shown in FIG. 2A, a composition structure selector 212 can be selected using an input device. FIG. 2A particularly illustrates the use of a pointing device that allows a user to interact with the graphical user interface (GUI) by controlling the movement of a cursor 210 on the composition canvas area 204. It should be understood that other types of input devices can be used, such as a touchscreen or voice commands.

When selected, the graphical user interface presents a list of composition structures 214 listing selectable composition structure types. Selecting a composition structure type from the list of composition structures 214 assigns a corresponding composition canvas area to that particular composition structure type. In this example use case, a pre-chorus-type composition structure has been selected. As there may be multiple composition structures of the same type, in some embodiments, the sequence of composition structures can be assigned.

In some embodiments, the order designation of a particular composition structure in the sequence of composition structures can be automatically designated, for example, by a composition structure sequence operation that sequentially numbers each composition structure based, how many of the same types of composition structures are in the digital composition, and the position of the composition structure within the digital composition.

Multiple composition canvas areas can be generated to form a digital composition, where each composition canvas area represents one or more tracks that can be played by the computing device. A user can reorder a particular composition canvas area within multiple composition canvas areas, thereby reordering the composition structure sequence. In some embodiments, if a composition structure type (such as “Pre-Chorus 1”) is moved from its original position in the sequence of composition structures, its identifying number will automatically change to reflect its new order in the sequence of similar composition structure types (for example, from “Pre-Chorus 1” to “Pre-Chorus 3”).

In some embodiments, a lyrics file containing lyrics and lyrics metadata is loaded. In some embodiments, the lyrics file is loaded separately from graphical elements and the parameter values corresponding to the graphical elements. The lyrics metadata, in some embodiments, contains one or more composition structures that are associated with portions of the lyrics. The specific standard for loading lyrics and composition structures and the methods for doing so may vary. One example file format that can be used for storing and exchanging lyrics and associated metadata is the LRC format for displaying lyrics synchronized with music, or the MusicXML format for exchanging musical scores and associated metadata. LRC stands for “Lyrics (with) Reduced Characters”, and it is a text-based file format that specifies the timing of lyrics and their corresponding text. LRC files, in some embodiments, are used to display the lyrics synchronized in time with the music and highlighted. The LRC format typically consists of timestamped lines of text, where each line corresponds to a specific section of the song and includes the time at which the lyrics for that section should be displayed. The format may also include additional metadata such as the title and artist of the song. The MusicXML format is a file format for exchanging musical scores and associated metadata between different software applications. MusicXML is an XML-based format that can represent the full range of musical elements, including notation, lyrics, chord symbols, and performance data. MusicXML files can be used for a variety of purposes, such as creating and sharing musical scores, importing and exporting music notation data between different software applications, and generating audio files or MIDI data for playback.

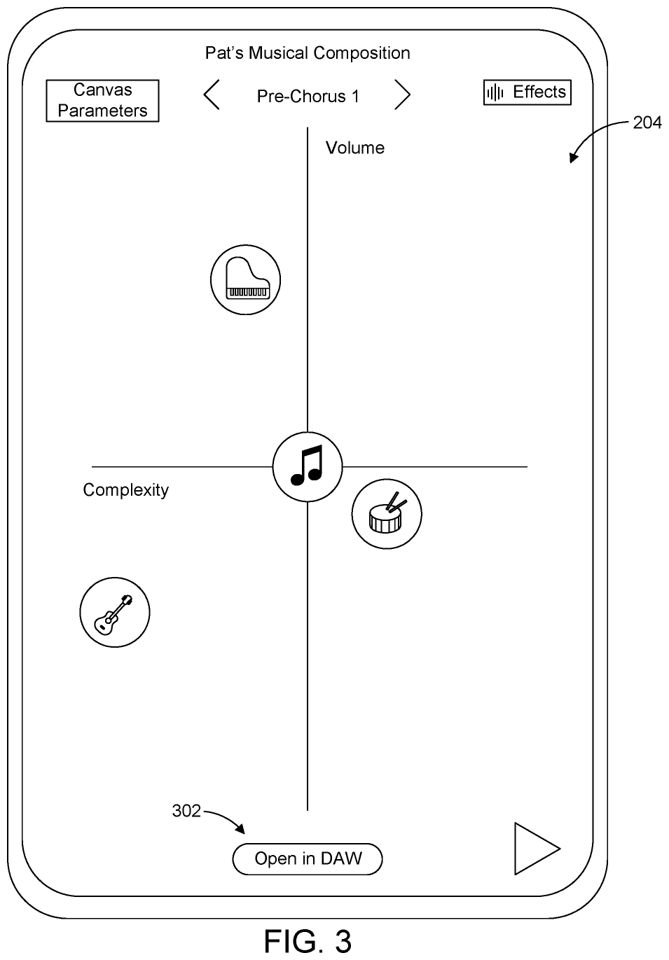

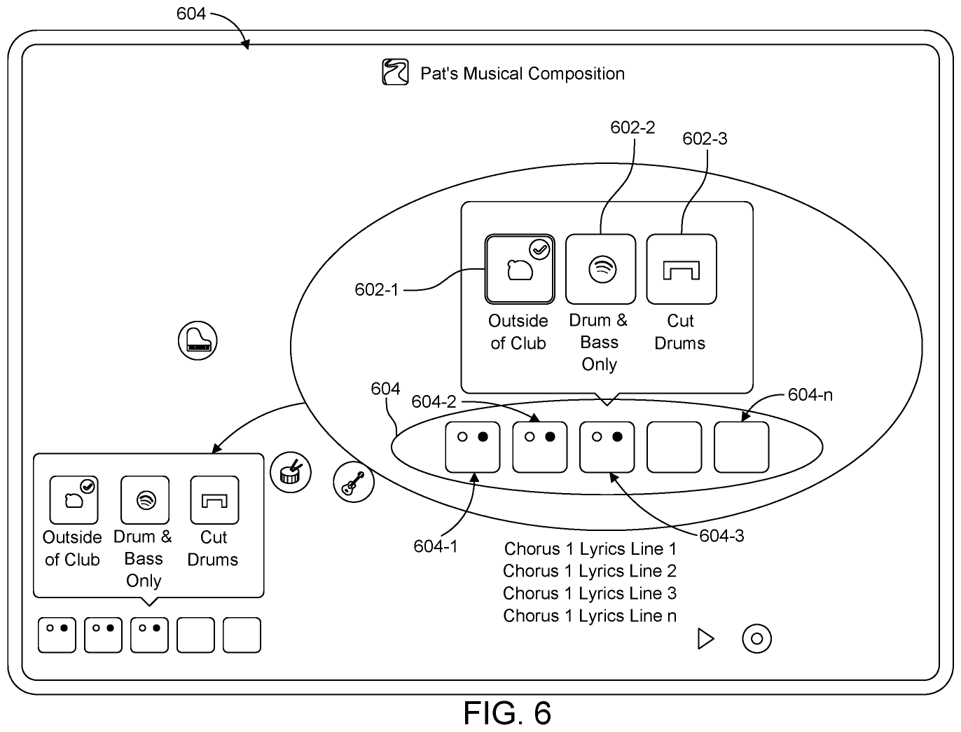

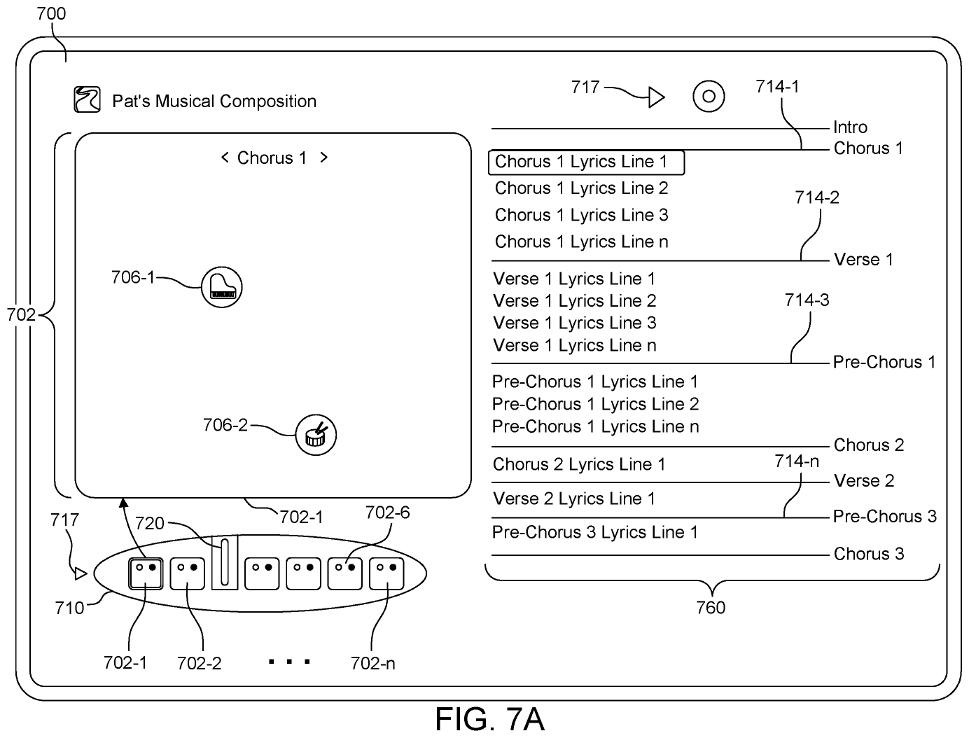

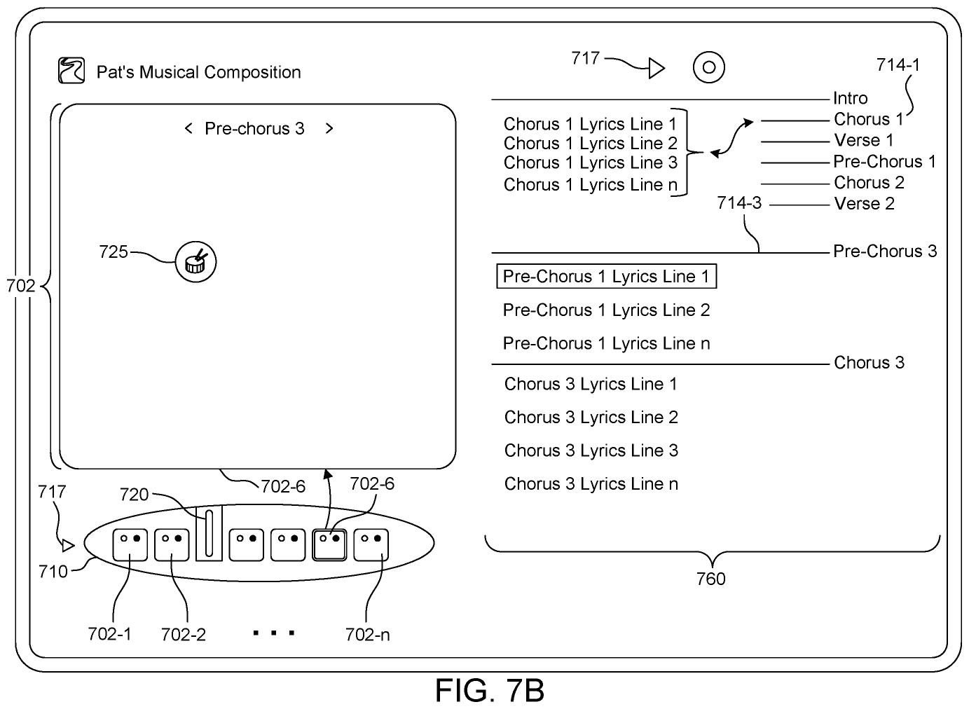

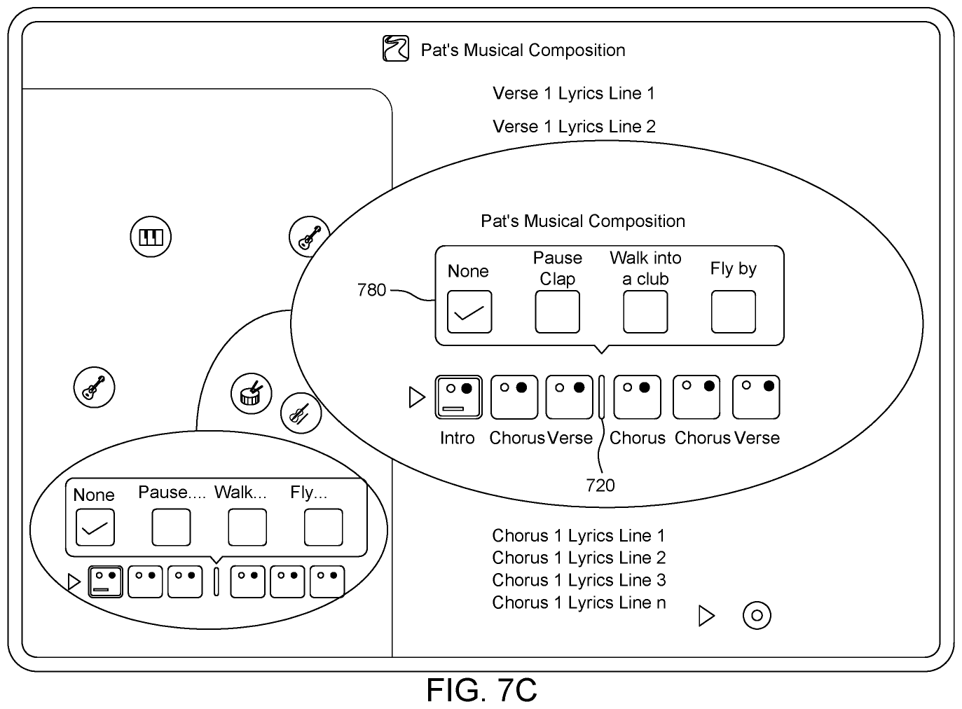

In the embodiment depicted in FIGS. 2A, 2B, 2C, 2D, 2E, 2F, 2G and 3, lyrics are not presented via the graphical user interface. However, in the embodiments depicted in connection with FIGS. 6, 7A, 7B, and 7C, lyrics are presented via the graphical user interface.

In some embodiments, one or more global parameter value modifiers 222 (depicted as “Canvas Parameters” in FIG. 2A) can be modified for a particular composition canvas area 204. Example global parameter value modifiers include speed and pitch. Other parameter value modifiers can be presented in the list and modified. The one or more global parameter value modifiers 222 can be modified to modify the global parameter values for the corresponding composition canvas area 204. In addition, the one or more global parameter value modifiers can cause the properties of a set of tracks associated with the composition canvas area 204 to be modified. In some embodiments, global parameter values are applied to a content composition system.

FIG. 2B illustrates a composition canvas area 204 of FIG. 2A being populated with graphical elements using an input device, according to an example embodiment. In this use case, the title 205 has been designated “Pat's Musical Composition” and the composition structure type selected by the user is pre-chorus. In this example use case, the composition structure is the first of its type and therefore has been labeled as the first pre-chorus-type composition structure (i.e., “Pre-Chorus 1”).

The lyrics and lyrics metadata including the composition structures can be loaded independent of the corresponding non-lyric portions of the digital composition (e.g., using LRC or MusicXML formatted files).

The graphical user interface of computing device 200 operates to display the composition canvas area 204 and populate the composition canvas area with graphical elements that represent (i) a track, (ii) one or more instruments, or (iii) an additional user (e.g., first additional user, second additional user, etc.). In some embodiments, the graphical elements are overlayed onto the composition canvas area 204 to abstract one or more tracks associated with a graphical element and therefore also the digital composition. A user without prior experience with creating digital compositions should find the embodiments of interfaces described herein more intuitive relative to, for example, conventional DAWs.

FIG. 2B further illustrates the use of a pointing device that allows a user to interact with the graphical user interface (GUI) by controlling the movement of a cursor 210 on the composition canvas area 204 and select a position for the placement of a graphical element 216-1. When a user selects a location on the composition canvas area 204 with the input device, a graphical element 216-1 appears. In this example, when graphical element 216-1 is released onto the composition canvas area 204 (e.g., the screen), a list of selectable types of graphical elements is presented, as shown in FIG. 2C.

FIG. 2C illustrates a list of selectable graphical elements 218 from which a user can select to designate a type of graphical element, in accordance with an example embodiment. In other words, the list of selectable graphical elements 218 enables the user to select a preset graphical element representing any one of (i) a track, (ii) one or more instruments, or (iii) an additional user (e.g., first additional user, second additional user, etc.).

In some embodiments, the graphical element defaults to a predetermined graphical element and is released onto the composition canvas area 204. When the default graphical element is selected, an option is provided to change what the predetermined graphical element represents.

The list of selectable graphical elements 218 in FIG. 2C is exemplary. In this example, the list of selectable graphical elements 218 includes a lead instrument, a chord player, a bass, a beat maker, and an effects maker.

The list of selectable graphical elements 218 in this example implementation also includes the ability to select a particular track from a datastore of one or more pre-composed tracks. In addition, the list of selectable graphical elements 218 includes the ability to add an additional user associated with predefined parameter values (e.g., a predefined parameter value that points to tracks associated with the additional user). Other types of tracks, instruments, or additional user(s) can be added or removed from the list depicted in the example shown in FIG. 2C. In this example, the user has selected using cursor 210 a lead instrumental type graphical element for graphical element 216-1 and in particular a graphical element representing a guitarist, as shown in FIG. 2C and FIG. 2D.

By selecting a graphical element representing a particular instrument, track or additional user, certain parameter values are retrieved to be applied to a content composition system. In particular, these parameter values are used by the content composition system to produce a digital composition. In some implementations, these parameter values are used by the content composition system to select prestored tracks to be combined and/or modified to produce a digital composition. In yet other embodiments, these parameter values are used by the content composition system to select prestored properties to be combined and/or modified to produce a digital composition.

FIG. 2D illustrates how a graphical element that has been selected can be modified, according to an example embodiment. As shown in FIG. 2D, a graphical element, such as graphical element 216-1, can have one or more modifier graphical elements 220-1, 220-2, 220-3, 220-4 presented via the graphical user interface of computing device 200. The one or more modifier graphical elements 220-1, 220-2, 220-3, 220-4 are used to modify a graphical element that has been overlayed (e.g., placed or released) onto the composition canvas area 204. The modifier graphical elements 220-1, 220-2, 220-3, 220-4 are sometimes referred to individually as a modifier graphical element 220 for convenience. In this example use case, when a modifier graphical element 220 is selected using an input device (e.g., using cursor 210), the properties of the graphical element change. For example, when first modifier graphical element 220-1 or second modifier graphical element 220-2 is selected, the type of graphical element changes to another type of graphical element (e.g., a guitar instrument to a piano instrument). Third modifier graphical element 220-3 or fourth modifier graphical element 220-4 can be selected to modify additional properties associated with the selected graphical element 216, such as timbre, distribution, tone, pitch, attack, or the like.

In some embodiments, after the content composition system has produced a digital composition, a play control graphical element 217 is presented. Selecting the play control graphical element 217 causes the digital composition to be played back, such as via the speakers of computing device 200 or other output device communicatively coupled to the computing device 200 (e.g., Bluetooth headphones, connected speakers, vehicle media system, and the like).

FIG. 2E illustrates a composition canvas area 204 where a graphical element 216-1 has been changed from one type of instrument to another type of instrument, according to an example embodiment. FIG. 2E particularly illustrates a composition canvas area 204 where graphical element 216-1 has been changed from a guitar instrument to a piano instrument.

In some embodiments, when a graphical element has been changed from one instrument to another, the presets corresponding to that graphical element change, causing the parameter values associated with that graphical element to change. In some embodiments, changing the type of graphical element causes tracks associated with that graphical element to change accordingly.

As shown in this example use case, the user can select a particular graphical element 216, such as graphical element 216-4 and remove it along with its associated parameter values by, for example, moving it onto a deletion graphical element 219.

The canvas composition area 204 can thus represent multiple tracks of a digital composition, where the particular tracks of the digital composition are not presented as they would using a DAW. Instead, the composition canvas area 204 uses graphical elements 216 to abstract the tracks of the digital composition making digital composition production relatively simpler. As will be explained in more detail below, this is accomplished by a user placing the graphical elements at certain locations on the composition canvas area 204.

In some embodiments, an instrument or additional user can correspond to a bandmember of a band. Such a bandmember is also referred to as virtual bandmembers. As such, parameter values corresponding to virtual bandmember attributes can be modified. The virtual bandmember parameter values are, in turn, applied to the content composition system to produce yet further unique digital compositions. For example, a virtual bandmember can correspond to a particular lead instrumentalist having unique attributes. Such parameter values can, for example, correspond to technical proficiency, expressiveness, versatility, melodic sensibility, and tonal quality, to name a view. Technical proficiency parameter values, for example, can correspond to a level of technical skill, whether the ability to shred on a guitar, play complex runs on a keyboard, or execute tricky rhythms on drums. Expressiveness parameter values can, for example, correspond to emotion and nuance to a song through phrasing, dynamics, and tone. Versatility parameter values can, for example, correspond the ability to switch between playing techniques such as fingerpicking, strumming, or using a bow. Melodic sensibility parameter values, for example, can correspond to a main melody or hook of a song. Tonal quality parameter values, for example, can correspond to the tone of a lead instrument. For example, tonal quality parameter values for a guitar might involve a bright, jangly sound or a dark, heavy sound parameter values. In some embodiments, a user provides user input that specifies what kind of role they want the virtual bandmember to play. For example, the user might specify that they want a lead guitarist with a bluesy playing style, or a keyboard player who can create ambient textures. A user can also, for example, specify that they want a guitarist who tends to play fast, intricate solos, or a drummer who likes to experiment with odd time signatures. Referring again to FIG. 2D, such user input can be entered, for example, by selecting a graphical element 216 and, depending on the parameter values, select third modifier graphical element 220-3 or fourth modifier graphical element 220-4 which, when selected provide selectable parameter values for the selected graphical element 216.

FIG. 2F illustrates a composition canvas area 204 on which various graphical elements 216-1, 216-2, 216-3, 216-5, have been overlayed on the composition canvas area 204. As shown in FIG. 2F, graphical element 216-4 illustrated on the composition canvas area 204 depicted in FIG. 2E (representing a string section) has been removed.

In this example, each graphical element 216 represents one or more tracks, instruments or additional users. In other words, various instruments, where each instrument is associated with a set of parameter values, have been selected and placed onto the canvas composition area 204. All the parameters values are, in turn, fed to a content composition system executed by the computing device 200 to produce a digital composition.

In some embodiments, one or more global parameter value modifiers 222 can be modified for a particular composition canvas area 204. Applying a global parameter value modifies to the content composition system modifies the digital composition corresponding to the current composition canvas area 204. In some embodiments, applying a global parameter value modifies to the content composition system modifies each composition structure of the digital composition (e.g., each composition canvas area 204 associated with the digital composition). Modifying the global parameter value modifier 222, in some embodiments, modifies a set of properties of a set of tracks associated with the composition canvas area 204. In the example use case shown in FIG. 2F, a speed global parameter value modifier has been selected from a list of selectable global parameters (not shown). In turn, an appropriate control graphical element 224 is presented. In this example use case, the speed global parameter value modifier has been selected from the list of selectable global parameters, and the control graphical element 224 corresponding to the selected global parameter value modifier is a slider type control.

In some embodiments, a particular graphical element can remain on the screen but be muted to provide the user the ability to test how different combinations of graphical elements affect the digital composition.

Referring to FIG. 1, in some example implementations, the method for electronically producing media content 100 involves a parameter determination operation 108. The parameter determination operation 108 performs determining one or more parameter values for each of the one or more graphical elements based on the location of the one or more graphical elements. In turn, a parameter application operation 110 performs producing at least the section of the digital composition based at least in part on (i) the media content represented by each of the one or more graphical elements and (ii) the one or more parameter values.

In some embodiments, the method for electronically producing media content 100 involves a parameter receiving operation 112 that performs receiving, via the one or more input devices, one or more parameter values associated with the one or more graphical elements, the one or more parameter values representing (i) a predetermined playing style, (ii) a timbre value corresponding to a predetermined style of music, (iii) a complexity value corresponding to a degree of complexity of the digital composition, or (iv) any combination thereof. In turn, digital composition production operation 106 performs producing the digital composition based at least in part on (i) the media content represented by each of the one or more graphical elements and (ii) the one or more parameter values.

FIG. 2G illustrates a composition canvas area 204 on which a user has modified the parameter values (e.g., properties) associated with graphical elements, according to an example embodiment. Moving a graphical element 216 vertically (e.g., in the Y axis) or horizontally (e.g., in the X axis) will affect the parameter values associated with the graphical element 216 being positioned at a different location and hence will affect the digital composition. In this example implementation, moving a graphical element 216 in the Y-axis adjust the volume associated with the graphical element 216. In the example use case shown, the volume of the guitar instrument graphical element 216-3 is lowered.

In some embodiments, when any of the graphical elements 216 move through an X and Y dimension of the composition canvas area, various traits of the digital composition change. Such traits include rhythmic and harmonic style, mood, emotion, complexity, volume, to name a few. Moving a graphical element 216 in the X-axis, for example, adjusts a specific property of the instrument represented by the graphical element 216. In the example embodiment, the degree of complexity of the piano instrument graphical element 216-1 is changed. In some embodiments, the degree of complexity corresponds to any one of (i) a predefined range of chord complexity, (ii) a predefined range of melodic complexity, (iii) a predefined range of chord-melody tension, (iv) a predetermined range of chord progression novelty, (v) a predetermined range of chord bass melody, (vi) a degree of instrumentational variety, (vi) a combination thereof.

It should be understood that other parameter value(s), whether received or determined based on graphical element locations can be applied to the digital composition and not necessarily cause or otherwise be used to modify aspects of the graphical elements themselves. For example, a parameter can be applied to a particular graphical element with respect to a section of the digital composition (e.g., a section of media content), that causes a digital filter to be applied to that section of the digital composition, without modifying the location or other property of the graphical element itself.

Referring again to FIG. 1, in some embodiments, the method for electronically producing media content 100 involves an additional user selection receiving operation 114 that performs receiving, via the one or more input devices in association with a first user, a selection of one or more additional users. A media content item retrieval operation 116 performs retrieving, via the one or more input devices, one or more media content items. For example, in response to receiving a selection of one or more additional users corresponding to the selection of one or more additional users, one or more media content items are retrieved. In this example, generating the digital composition by digital composition generation operation 106 is based, in part, on one or more of the media content items corresponding to the additional users.

In some embodiments, a list of the one or more additional users are obtained based on a listening history of the first user and a graphical image presentation operation 118 performs presenting, via the graphical user interface, one or more selectable graphical images each representing one of the one or more additional users.

In some embodiments, the method for electronically producing media content 100 involves a canvas combination operation 120 that performs combining two or more composition canvas areas. The result is the combination of two or more sections of a digital composition. An effect selection operation 122 performs receiving, via the one or more input devices, a selection of a predetermined effect from a plurality of predetermined effects and applying the predetermined effect to at least one of the two or more sections of the digital composition.

In some embodiments, graphical element location selection operation 104 further involves a position modification operation 126 that performs receiving, via the one or more input devices, a position modification instruction to move a first graphical element of the one or more graphical elements from a first location on the composition canvas area to a second location on the composition canvas area. In these embodiments, digital composition production operation 106 further involves a digital composition modification operation 128 that performs producing at least a section of the digital composition by modifying the digital composition based on the position modification instruction. In an example implementation, modifying the digital composition based on the position modification, further includes modifying the digital composition based on a positional relationship between the first graphical element and one or more other graphical elements on the composition canvas area.

In some embodiments, a position modification operation 126 performs receiving, via the one or more input devices, a position modification instruction to move a first graphical element of the one or more graphical elements. In these embodiments, when the position of a first graphical element is moved along an X-axis of the composition canvas area, a first set of composition parameter values change, and when the position of the first graphical element is moved along the Y-axis of the composition canvas area, a second set of composition parameter values change. In turn, the digital composition is produced, at least in part, based on one or more of the first set of composition parameter values or the second set of composition parameter values.

In some embodiments, graphical element location selection operation 104 further involves receiving, via the one or more input devices, a graphic element selection of a first graphical element from the one or more graphical elements on the composition canvas area that causes a parameter prompt to be presented via the graphical user interface. In turn a parameter input receiving operation performs receiving, via the one or more input devices, a parameter modification instruction causing a parameter value associated with the first graphical element to be modified, thereby generating a modified parameter value. In these embodiments, digital composition modification operation 128 performs modifying the digital composition based on the modified parameter value.

In some embodiments a toggle operation 130 performs presenting, via the graphical user interface, a selectable toggle graphical element, which when selected causes graphical user interface to switch between presenting a digital audio workstation interface and the composition canvas. In an example implementation, the digital audio workstation interface presents any one or a combination of (i) a mixer-based layout, (ii) a waveform-based layout, and (iii) a clip-based layout.

FIG. 3 illustrates a composition canvas area having a toggle 302 that can be selected to switch between presenting a digital audio workstation interface and the corresponding composition canvas area, according to an example embodiment. As shown in FIG. 3, because the current display shows a composition canvas area 204, the toggle 302 provides the option to switch to a digital audio workstation (DAW) interface.

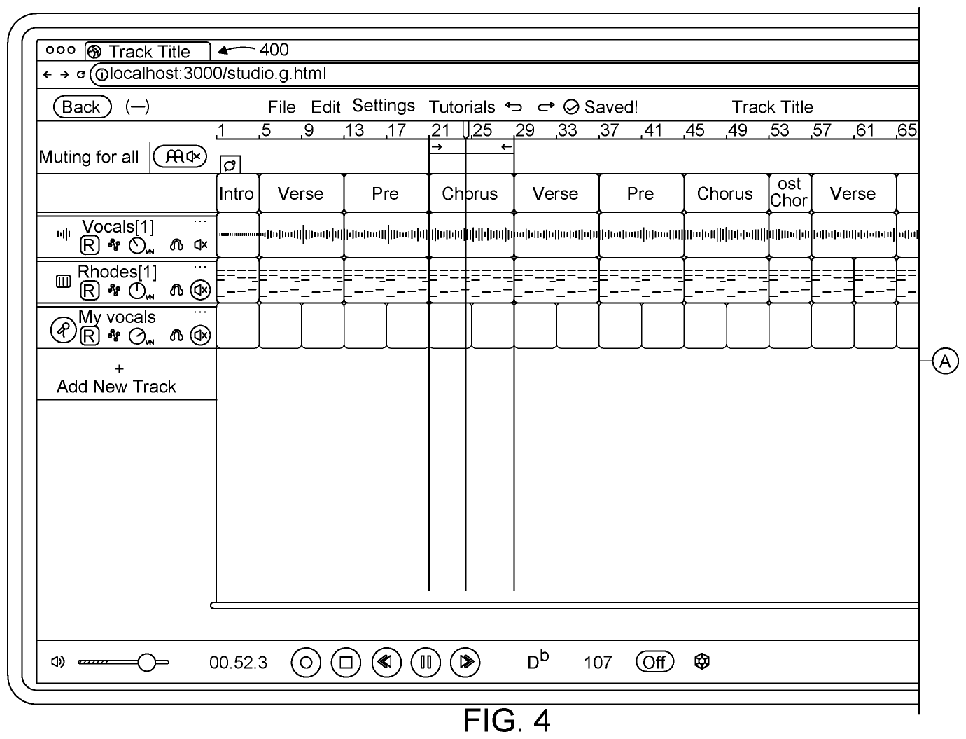

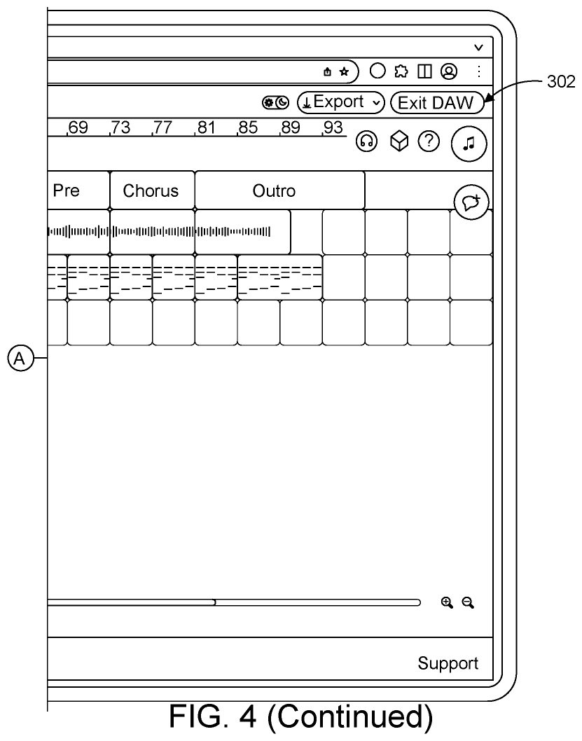

FIG. 4 represents an example digital audio workstation (DAW) interface 400, according to an example embodiment. The digital audio workstation interface 400 in this example presents a waveform-based layout. The DAW interface 400, in this example embodiment, shows a visual representation of an audio recording or a section of an audio recording. The waveform display provides a visual representation of the amplitude and frequency of the audio signal over time, with the amplitude represented on the vertical axis and time on the horizontal axis. The waveform shows the changes in the audio signal's amplitude over time, which helps the user to identify different elements in the audio recording such as individual instruments, vocal tracks, or sound effects. This layout is commonly used for audio editing, mixing, and mastering within a DAW, as it allows the user to make precise adjustments to the audio signal, such as trimming, cutting, and adjusting the volume or panning of individual tracks. However, as explained herein, such an interface requires relatively more effort from a user than a composition canvas area presented via a GUI according to the example embodiments described herein. As shown in FIG. 4, toggle 302 can be selected to exit the DAW interface 400 and go back to presenting the composition canvas area interface.

Referring again to FIG. 1, in some embodiments, composition canvas presentation operation 102 includes, before receiving the graphical element location selection, presenting via the graphical user interface, at least one of the one or more of the graphical elements on the composition canvas. In an example implementation, graphical element location selection operation 104 performs receiving, via the one or more input devices, a graphical element selection of at least one of the one or more graphical elements. In response to receiving the graphical element selection, graphical element location selection operation 104 further performs overlaying the graphical elements on the composition canvas.

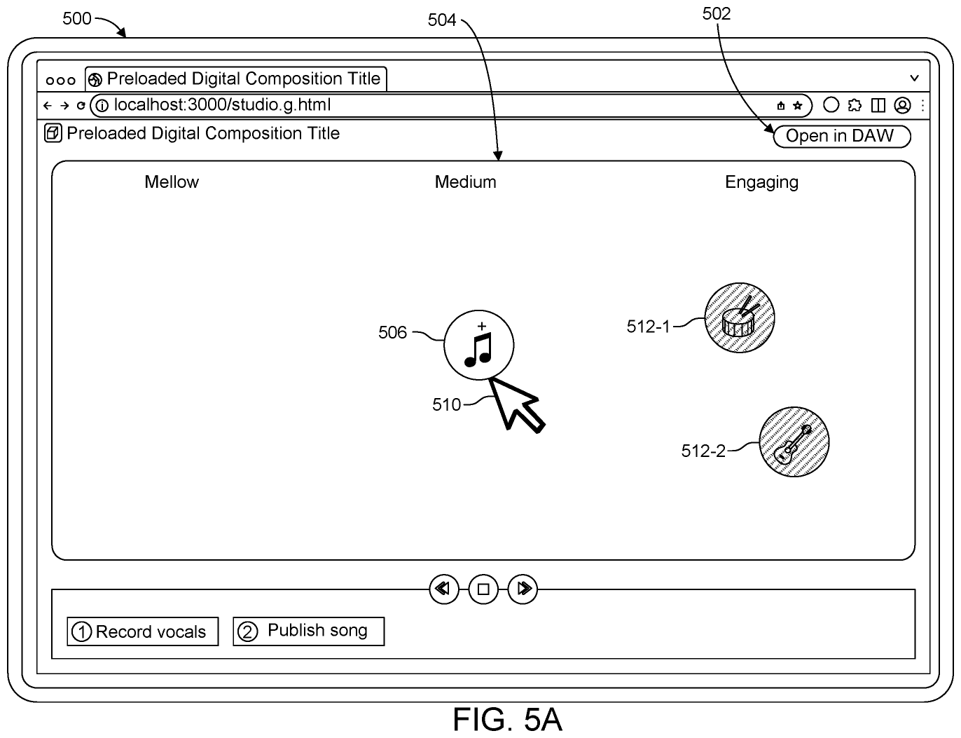

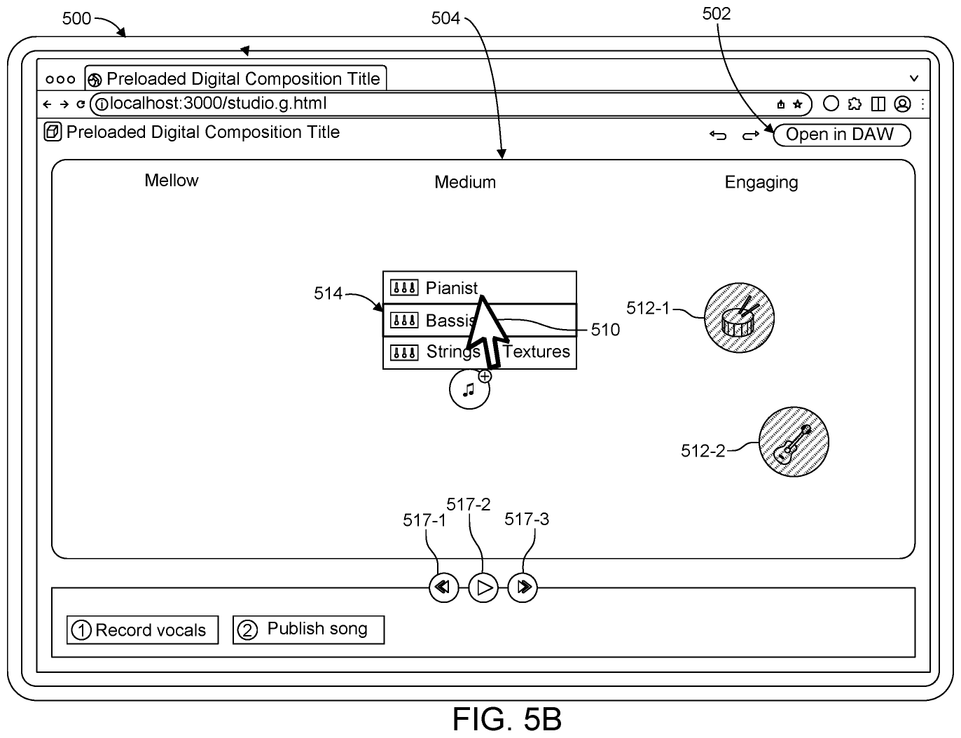

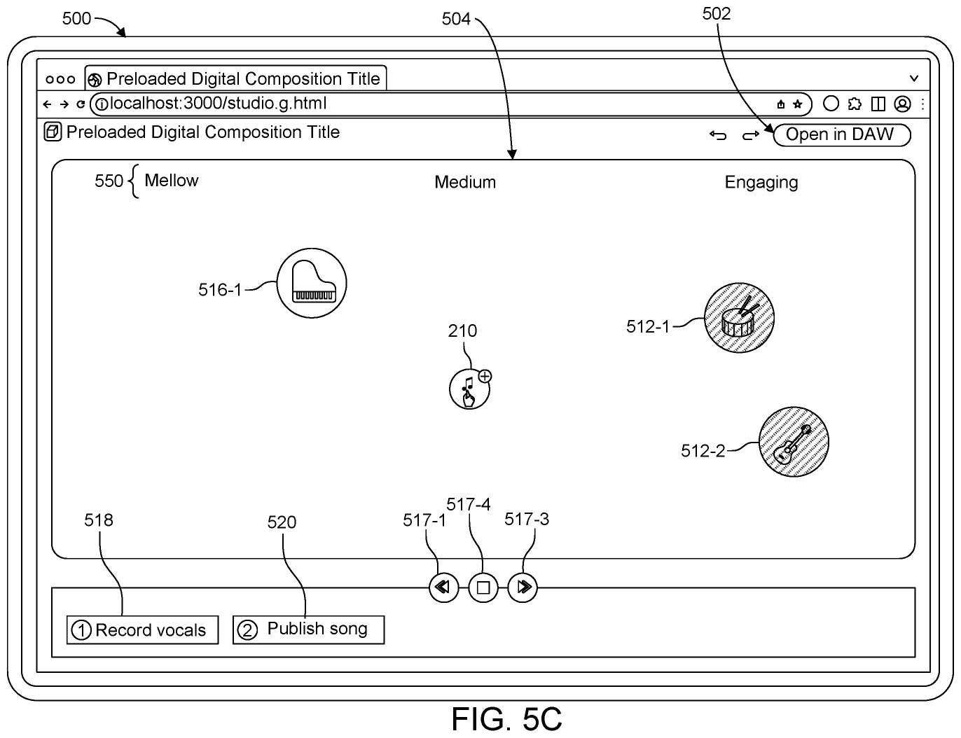

FIG. 5A illustrates a composition canvas area 504 presented via a graphical user interface of a computing device 500 for electronically producing media content, according to an example embodiment. In this example embodiment, a prearranged digital composition has been preloaded. In some embodiments, when a prearranged digital composition has been preloaded, various parameter values corresponding to the prearranged digital composition are loaded into non-transitory memory of the computing device 500. When a user adds or modifies a graphical element to the composition canvas area, the prearranged digital composition will change accordingly. In some example embodiments, a content composition system modifies the prearranged digital composition automatically. In some example embodiments, the content composition system modifies the prearranged digital composition upon receiving a play command, such as from a play graphical element 517-2 of FIG. 5B being selected using an input device.

In some embodiments, no prearranged graphical elements corresponding to the prearranged digital composition are depicted after the prearranged digital composition is loaded. When any graphical element is overlayed onto the composition canvas area 504, the corresponding parameter values associated with the graphical element (e.g., representing an instrument, track or additional user) are incorporated into the prearranged digital composition by the content composition system.

In some embodiments, when the graphical element is added to the composition canvas area 504, the corresponding instrument, track or additional user is added to the prearranged digital composition. In an example implementation, parameter values corresponding to the added graphical elements are applied to a content composition system. In this example, the parameter values corresponding to the added graphical elements are applied in addition to the parameter values corresponding to the prearranged digital composition that has been preloaded.

In some embodiments, when the graphical element is added to the composition canvas area, the corresponding instrument or track in the prearranged digital composition is modified. In an example implementation, this involves modifying the parameter values associated with the tracks of the prearranged digital composition.

Referring to FIG. 5A, in some embodiments, a prearranged digital composition includes prearranged graphical elements that, when loaded by the computing device 500 pre-populate the composition canvas area 504, as illustrated by prearranged graphical element 512-1 representing a drummer, and prearranged graphical element 512-2 representing a guitarist.

A user can, for example, use a pointing device 510 to interact with the graphical user interface (GUI) by controlling the movement of a cursor 510 on the composition canvas area 504. When a user selects the add graphical element 506, a list of possible graphical elements is presented via the GUI of computing device 500. In some embodiments, the list of possible graphical elements is based on the properties of the prearranged digital composition. For example, it may be the case that a vocalist cannot be added based on the properties of the prearranged digital composition do not allow a vocalist to be added. In such case, a graphical element corresponding to a vocalist will not be listed in the list of possible graphical elements.

As shown in FIG. 5A, because the current display shows a composition canvas area 504, the toggle 502 provides the option to switch to a digital audio workstation (DAW) interface.

FIG. 5B illustrates an example composition canvas area 504 being populated with a graphical element where a prearranged digital composition has been preloaded, according to an example embodiment. FIG. 5B further illustrates a list of selectable graphical elements 514 from which a user can select to designate a type of graphical element. In other words, the list of selectable graphical elements 514 enables the user to select a preset graphical element representing any one of (i) a track, (ii) one or more instruments, or (iii) an additional user (e.g., a first additional user, a second additional user, etc.).

In this example use case, the add graphical element 506 described above in connection with FIG. 5A has been selected using the one or more input devices. Upon the add graphical element 506 being selected, the GUI presents a list of selectable graphical elements 514 listing available graphical elements that can be selected using the input device. In this example use case, the list of possible graphical elements that can be selected using the input device includes a pianist-type graphical element, a bassist-type graphical element, and a string player-type graphical element. In this example use case, a pianist-type graphical element has been selected.

In addition, in this example implementation depicted in FIG. 5B, two pre-arranged graphical elements have been supplied with the pre-arranged digital composition, a first prearranged graphical element 512-1 representing a first instrument and prearranged graphical element 512-2 representing a second instrument. It should be understood that a prearranged digital composition need not include pre-arranged graphical elements. Additionally, more or fewer prearranged graphical elements 512 can be provided.

FIG. 5C illustrates a composition canvas area 504 being populated with one or more graphical elements using an input device, according to an example embodiment. FIG. 5C particularly illustrates a graphical element 516-1 that has been placed at a particular location on the composition canvas area.

By selecting a graphical element representing a particular instrument, track or additional user, certain parameter values are retrieved to be applied to the content composition system. In particular, these parameter values are used by the content composition system, in this example implementation to produce a digital composition that is a modification of a prearranged digital composition. In some embodiments, these parameter values are used by the content composition system to select prestored tracks to be combined with the prearranged digital composition.

In this example implementation, the location of the graphical element on the composition canvas area, modifies the prearranged digital composition. As illustrated in FIG. 5C, the graphical element 516-1 represents a pianist having parameter values corresponding to playing styles 550 that can be modified on an incremental basis. In this example implementation, the playing styles include mellow, medium and engaging. The setting of the playing styles can vary incrementally depending on the placement of the graphical element on the composition canvas area 504. Graphical element 516-1, in the example use case shown in FIG. 5C, has been placed between playing style parameter values corresponding to mellow and medium on a scale spanning between mellow and engaging with medium parameter value in the middle. The closer a graphical element is placed to mellow end, the more mellow any track associated with the graphical element will be.

Mellow, in this example implementation, refers to parameter values corresponding to a relaxed, smooth, and soothing sound, characterized by soft, warm tones and gentle rhythms of any track associated with graphical element 516-1. Medium, in this example implementation, refers to parameter values corresponding to a tempo of any track associated with graphical element 516-1. For example, the tempo can be at a moderate speed or pace. Engaging, in this example embodiment, refers to parameter values corresponding to the engagement level of any track associated with graphical element 516-1. For example, a track associated with graphical element 516-1 can have a relatively catchier melody, more interesting harmonies, or a compelling rhythm that captures the listener's attention relative to a less engaging track.

Other parameter values can be modified in addition to or instead of playing style. For example, parameter values corresponding to timbre, distribution, tone, pitch, attack, and the like, can be modified as well.

In some embodiments, the parameter values that can be modified for any particular graphical element can be abstracted for a user. For example, timbre can be limited to acoustic, studio, or electronic. That is timbre, which refers to the character or quality of a sound, can be categorized into three general types: acoustic, studio, or electronic. Acoustic timbre refers to the characteristic sound of instruments or vocals as they are naturally produced in a physical space, without the use of any amplification or electronic effects. Studio timbre refers to the way in which the sound is manipulated and processed during the recording or mixing process, often using various tools and effects available in a recording studio. Electronic timbre refers to the sound produced by electronic instruments such as synthesizers, which create sound using electrical signals and often have a distinct and artificial quality to their timbre. As another example, distribution can be abstracted to a predetermined number of possible choices. For example, distribution can be limited to chords, chords and melody, or melody. Distribution refers to the way that musical elements are arranged or spread across the digital composition. A distribution limited to chords means that the focus of any track associated with the corresponding graphical element is on the harmony or chord progression of the song, a distribution limited to chords and melody means that both the harmony and melody of any track associated with the corresponding graphical elements are emphasized elements of the digital composition's distribution. Distribution limited to melody means that the focus of the corresponding to any track associated with the corresponding graphical element is primarily on the melodic elements of the song.

Modification of parameters values such as the ones discussed above, adjust the complexity of the digital composition.

Therefore, the statement is suggesting that when discussing or analyzing the distribution of musical elements in a composition, it can be helpful to consider which of these predetermined categories the distribution falls into.

In some embodiments, one or more playback control graphical elements 517 are presented on the composition canvas area 504. The one or more playback control graphical elements 517 are provided to provide playback control (e.g., play, stop, forward, rewind). In the example embodiment depicted in FIG. 5B and FIG. 5C, selecting by an input device the play control graphical element 517-2 (FIG. 5B) causes the digital composition produced by the content composition system to be played back, such as via the speakers of computing device 500 or other output device communicatively coupled to the computing device 500 (e.g., Bluetooth headphones, connected speakers, vehicle media system, and the like). Upon playing the digital composition, the play control graphical element 517-2 can dynamically change to a stop control element 517-4 as shown in FIG. 5C. Rewind control graphical element 517-1, when selected by the input device, causes the digital composition to skip backward and the forward control graphical element 517-3, when selected by the input device, causes the digital composition to skip forward. In some embodiments, the rewind control graphical element 517-1 and the forward control graphical element 517-3 moves the position of the digital composition to a previous lyrics composition structure or to a next composition structure, correspondingly. This allows the composition canvas area 504 to be produced for a corresponding lyrics composition structure.

In some embodiments, when a graphical element has been changed from one type of instrument to another, the presets of that graphical element change, causing the parameter values associated with that graphical element to change. In some embodiments, changing the graphical element from one type of instrument to another causes tracks associated with that graphical element to change accordingly.

The composition canvas area 504 can thus represent multiple tracks of a digital composition, where the particular tracks of the digital composition are not presented via the composition canvas area as they would using a DAW. Instead, the composition canvas area uses graphical elements to abstract the tracks of the digital composition.

Placing the graphical elements at certain locations on the composition canvas area 504 modifies the digital composition, which in this example embodiment involves a prearranged digital composition.

In some embodiments, when a prearranged digital composition has been preloaded, various parameter values corresponding to the prearranged digital composition are loaded into the computing device. When a user adds a graphical element to the composition canvas area or modifies a graphical element that is already on the composition canvas area, the properties of the prearranged digital composition will change accordingly. In some example embodiments, a content composition system modifies the prearranged digital composition automatically. In some example embodiments, the content composition system modifies the prearranged digital composition upon receiving a regenerate command, such as from a play control graphical element 517-2 (or other independent graphical element specifically for controlling regeneration; not shown) being selected using an input device.

In some embodiments, prearranged graphical elements corresponding to the prearranged digital composition are not depicted after the prearranged digital composition is loaded. When any graphical element is overlayed onto the composition canvas area, the corresponding parameter values associated with the graphical element (e.g., representing an instrument, track or additional user) are incorporated into the prearranged digital composition by the content composition system. When a graphical element is added to the composition canvas area, a corresponding instrument, track or additional user is added to the prearranged digital composition. In an example implementation, parameter values corresponding to the added graphical elements are applied to a content composition system in addition to the parameter values corresponding to the prearranged digital composition that has been preloaded.

In some embodiments, when the graphical element is added to the composition canvas area, the corresponding instrument or track in the prearranged digital composition is modified. In an example implementation, this involves modifying the parameter values associated with the tracks of the prearranged digital composition.

A user can, for example, use a pointing device to interact with the graphical user interface (GUI) by controlling the movement of a cursor on the composition canvas area 504. When a user selects the add graphical element 506, a list of possible graphical elements is presented via the GUI of computing device. In some embodiment, the list of possible graphical elements is based on the properties of the prearranged digital composition. For example, it may be the case that a vocalist cannot be added based on the properties of the prearranged digital composition. In such case, a graphical element corresponding to a vocalist will not be listed in the list of possible graphical elements.

How graphical elements can be added to the composition canvas area and/or modified has already been described above. Therefore, those descriptions are not repeated.

Additional graphical elements can be added to the composition canvas area 504. Thus multiple parameter values associated with multiple graphical elements can be combined and applied to the content composition system to modify the prearranged digital composition. In addition, for ease of experimentation, graphical elements that have already been overlayed onto the composition canvas area 504 can be muted, for example by selecting a mute graphical element (not shown). This allows a user to modify the prearranged digital composition by experimenting with different types of graphical elements.

In some embodiments, a user can record vocals by selecting a record vocals graphical element 518 and recording voice via an input device such as a microphone. In addition, a user can publish a digital composition (e.g., a song) created using the embodiments described herein by selecting a publish song graphical element 520.

FIG. 6 illustrates a graphical user interface that provides selectable effects graphical elements 602 for adding effects and variety to one or more composition canvas areas 604 of a digital composition, according to an example embodiment. The selectable effects graphical elements 602 illustrated in FIG. 6, which are exemplary, include outside a club 602-1, drum & bass only 602-2, and cut drums 602-3. The default effect can be set to none. Other effects can be presented such as drums only and clap & bass, both not shown in FIG. 6. In an example implementation, the effects applied as digital signal processing (DSP) settings that alter the sound of the audio signal passing through the tracks corresponding to one or more composition canvas areas 604. In other words, the selected one or more effects can be applied globally to multiple tracks by the content composition system, for example, by using a bus or a group. A bus is a virtual channel in a content composition system that enables audio to be retrieved from multiple tracks to a common destination, such as a master channel or an auxiliary track. By sending the audio from multiple tracks to a bus, track effects can be applied to one or more composition canvas areas and in turn to one or more associated tracks, at once. For example, a bus can be created and sent the audio from all the drum tracks to that bus. Then, the “cut drums” 602-3 effect would be applied to the bus, and it would be applied to all the drum tracks at once.

A group is similar to a bus, but it also allows a content composition system to control the levels and other parameters of the tracks that are assigned to it. A group can be created and assigned multiple tracks to it, and then apply track effects to the group. This way, the same effect to multiple composition canvas areas and any associated tracks while also controlling their levels and other parameters.

FIG. 6 also illustrates how multiple composition canvas areas 604 can be abstracted. As shown in FIG. 6, each composition canvas area that forms a digital composition is represented by composition canvas area graphical elements 604-1, 604-2, 604-3, . . . , 604-n. In the example use case depicted in FIG. 6, the effects are applied globally to all the canvas areas. It should be understood that the effects can be applied to one or more selected composition canvas areas and not necessarily all of them.

Referring again to FIG. 1, in some embodiments, after the canvas combination operation 120 performs combining two or more composition canvas areas, a transition content receiving operation 124 performs receiving, via the one or more input devices, a selection of a transition content item from a plurality of transition content items and inserting the transition content item between two composition canvas areas of the two or more composition canvas areas. The result is a digital composition having two or more sections that are combined with transitions between them.

In some embodiments, combining two or more composition canvas areas enables two or more sections of a digital composition to be combined. Each section may have its own corresponding canvas area. In an example implementation, each composition canvas area corresponds to a lyrics composition structure of plural lyrics compositions structures. In addition, each composition canvas area is synchronized with an associated lyrics composition structure so that as the composition canvas area is played, the corresponding line of lyrics can be highlighted on the graphical user interface for the user.

In some embodiments, various sections of the digital composition can be navigated from any given canvas. This feature is enabled using a media content navigation operation that allows a user to interact with multiple canvases via the graphical user interface, with each canvas area representing a distinct section of the digital composition. For example, a user can work on composing a song section via one composition canvas area that corresponds to that particular song section, and then change by selecting a graphical element that represents a canvas as opposed to a particular instrument or pre-modeled user. This enables a user to jump from canvas to canvas so as to enable a user to quickly navigate to different song sections.

FIG. 7A illustrates an example graphical user interface 700 for navigating between different composition canvas areas corresponding to sections of a digital composition, according to an example embodiment. Generally, in some embodiments, multiple composition canvas areas of a digital composition can be represented by graphical elements referred to as canvas graphical elements so as to fit on the same screen of a computing device multiple composition canvas areas sections of the digital composition. In addition, corresponding sections of the lyrics can be presented on the same screen.

In the example implementation shown in FIG. 7A, to the right of the graphical user interface is presented a lyrics area 760 that presents the lyrics of a digital composition. To the left of the graphical user interface is presented one composition canvas area 702 that forms a section of a digital composition, which in this example implementation corresponds to an instrumental section of the digital composition. As shown in the example use case of FIG. 7A, two graphical elements are overlayed onto composition canvas area 702-1, a first graphical element 706-1 representing a piano and a second graphical element 706-2 representing a drum.

Each composition canvas area that forms the digital composition is represented by a canvas graphical element 702-1, 702-2, . . . , 702-n (collectively and individually sometimes referred to for simplicity as canvas graphical element 702). In other words, each canvas graphical element 702-1, 702-2, . . . , 702-n corresponds to a section of the digital composition and a collection of canvas graphical elements 710 thus represents the digital composition. In this example use case, the selected canvas area represented by canvas graphical element 702-1 represents the composition canvas area 702-1 currently presented via the graphical user interface.

In some embodiments, the canvas graphical element represents a section of the lyrics of the digital composition with no instrumental section. In some embodiments, the canvas graphical element represents a section of the lyrics of the digital composition with an instrumental section. In some embodiments, a canvas graphical element represents an instrumental section of the digital composition.

In some embodiments, a canvas graphical element can represent a transition between two sections of the digital composition. A canvas graphical element that represents a transition is also sometimes referred to and depicted as, a transition graphical element 720 corresponding to a transition content item. An example embodiment of a mechanism for adding transitions is described below in connection with FIG. 7C.

The graphical user interface depicted in FIG. 7A represents a structure of the digital composition in both in the composition canvas areas and lyrics areas. This embodiment makes it easier for users with little or no content creation experience to create digital compositions or to modify pre-existing digital compositions by making intuitive the connection between, for example, the instrumental sections of a digital composition and the lyrics of the digital composition.

Selecting the play graphical element 717 will cause the playback device to play back the digital composition. In an example embodiment, the playback device will play back each section of the digital composition, highlighting the digital composition area currently being played back.

In some embodiments, a lyrics section selection operation performs receiving a lyrics section graphical element 714-1, 714-2, . . . , 714-n, where each lyrics section graphical element 714 corresponds to a particular lyrics section within the digital composition. The selection causes the playback of the digital composition to jump to the section of the digital composition containing the selected lyrics section (i.e., the selected lyrics section graphical element 714). In some embodiments, the canvas graphical element 702 corresponding to the selected lyrics section is highlighted as active. In some embodiments, the lyrics themselves are highlighted in synchronization with the portion of the digital composition being played back via the playback device.

In some embodiments, when a composition canvas area is selected, the graphical elements corresponding to the selected composition canvas area are displayed on the composition canvas area. This allows a user to visualize changes in individual composition canvas areas as well as across multiple composition canvas areas dynamically. It further allows users to visualize changes in the digital composition when they move the individual graphical elements corresponding to a particular canvas area within a composition canvas area so that the changes they make are more relatable to the digital composition when it is played back.

FIG. 7B illustrates an example graphical user interface for navigating between different composition canvas areas corresponding to sections of a digital composition, according to an example embodiment. In the example use case depicted in FIG. 7B, a user has selected canvas graphical element 702-6. Selecting the canvas graphical element 702-6 causes the composition canvas area 702 to change to composition canvas area 702-6.

As shown in the example use case of FIG. 7B, one graphical element 725 is overlayed onto composition canvas area. In this example embodiment the graphical element 725 represents a drum.

The selection from one composition canvas area to another causes the playback of the digital composition to jump to the section of the digital composition containing the selected lyrics section (i.e., the selected lyrics section graphical element 714). As shown in this example implementation, the canvas graphical element 702-6 corresponding lyrics section 714-3, which has a line of the lyrics in that composition structure that is highlighted as active (“Pre-Chorus 1 Lyrics Line 1”). Thus, as shown in FIG. 7A and FIG. 7B, the lyrics area 760 presents the lyrics section of a digital composition according to the selection of a corresponding composition canvas area and enables a user to easily and intuitively switch from one lyrics section and/or composition canvas area to another.

FIG. 7C illustrates a method for adding transitions between digital composition sections, according to an example embodiment. After at least two composition canvas areas have been combined, a transition content item can be selected from a plurality of transition content items 780. The selected transition content item can, in turn, be inserted between two composition canvas areas, as depicted by transition graphical element 720 corresponding to a transition content item in FIG. 7C. The result is a digital composition having two or more sections that are combined with one or more transitions between them.

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

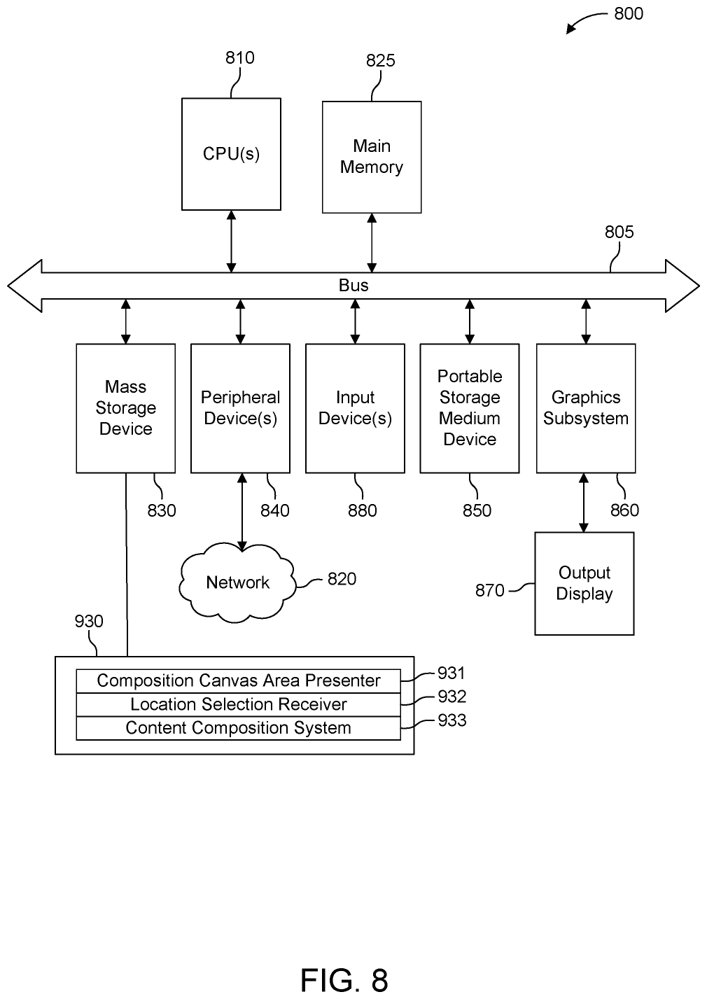

FIG. 8 is a block diagram of a system 800 for providing graphical user interfaces for producing digital content according to the example embodiments described herein.

The system 800 includes one or more central processing units (CPUs) 810, a main memory 825, and an interconnect bus 805. The main memory 825 stores, among other things, instructions and/or data for execution by the CPU(s) 810. The main memory 825 may include non-transitory random-access memory (RAM), as well as non-transitory cache memory.

System 800 may further include a non-transitory mass storage device 830, peripheral device(s) 840, portable non-transitory storage medium device(s) 850, input device(s) 880, a graphics subsystem 860, and/or an output display interface 870. For explanatory purposes, all components in system 800 are shown in FIG. 8 as being coupled via the bus 805. However, the system is not so limited. Elements of system 800 may be coupled via one or more data transport means. For example, the CPU(s) 810 and/or the main memory 825 may be coupled via a local microprocessor bus. The mass storage device 830, peripheral device(s) 840, portable storage medium device(s) 850, and/or graphics subsystem 860 may be coupled via one or more input/output (I/O) buses. The mass storage device 830 may be a nonvolatile storage device for storing data and/or instructions 930 for execution by the CPU(s) 810. The mass storage device 830 may be implemented, for example, with a solid-state storage device, a magnetic disk drive, an optical disk drive, or the like.

In a software embodiment, the mass storage device 830 is configured for loading contents of the mass storage device 830 into the main memory 825.

For example, mass storage device 830 can store instructions 930 which, when executed by CPU(s) 810, cause the CPU(s) 810 to act as a composition canvas area presenter 931, a location selection receiver 932, and a content composition system 933. The composition canvas area presenter 931 operates to present, via a graphical user interface, a composition canvas area. The location selection receiver 932 operates to receive, via one or more input devices 880, a location selection for each of one or more graphical elements, where each of the one or more graphical elements represents media content including any one of (i) a track, (ii) one or more instruments, or (iii) an additional user, and wherein the location selection identifies a location on the composition canvas area at which to overlay a respective one of the one or more graphical elements. The content composition system 933 operates to produce at least a section of a digital composition based on the location of the one or more graphical elements on the composition canvas area. Mass storage device 830 can also store instructions 930, which when executed by the CPU(s), cause the CPU(s) to perform the methods and operations described herein.

The portable storage medium device 850 operates in conjunction with a nonvolatile portable storage medium, such as, for example, flash memory, to input and output data and code to and from the system 800. In some embodiments, the software for storing information may be stored on a portable storage medium and may be input into the system 800 via the portable storage medium device 850. The peripheral device(s) 840 may include any type of computer support device, such as, for example, an input/output (I/O) interface configured to add additional functionality to the system 800. For example, the peripheral device(s) 840 may include a modem and/or a network interface card (wired or wireless) for interfacing the system 800 with a network 820, an infra-red communication device, Bluetooth™ device, cellular communication device, or the like.

The input device(s) 880 provide a portion of the user interface for a user of the system 800. The input device(s) 880 may include a touch screen sensor, a microphone, a keypad and/or a cursor control device. The touch screen sensor may be configured to detect a user's touch if a screen with their finger and, in turn, send a signal to the operating system (OS) of the device. The OS then generates a touch event, which includes information about the location of the touch, and other relevant details. The touch event is, in turn, passed to the application or program that is currently running on system 800. The information is passed to the application or program is used to determine area of the screen was touched, and to perform an appropriate action in response to the touch.

The keypad may be configured for inputting alphanumeric characters and/or other key information. The cursor control device may include, for example, a handheld controller or mouse, a trackball, a stylus, and/or cursor direction keys. The system 800 may include an optional graphics subsystem 860 and output display 870 to display textual and graphical information. Output display 870 may include a display such as a CSTN (Color Super Twisted Nematic) display, an IPS-LCD (In-Plane Switching Liquid Crystal Display), a TFT (Thin Film Transistor) display, a TFD (Thin Film Diode) display, an OLED (Organic Light-Emitting Diode) display, an AMOLED (Active matrix organic light-emitting diode) display, and/or a liquid crystal display (LCD) display. The display can also be a touchscreen display, such as capacitive, resistive, infrared, or optical imaging-type touchscreen display.

The graphics subsystem 860 receives textual and graphical information and processes the information for output to the output display 870.

Input devices 880 can control the operation and various functions of system 800. Input devices 880 can include any components, circuitry, or logic operative to drive the functionality of system 800. For example, input device(s) 880 can include one or more processors acting under the control of an application.

The terminology used herein is for the purpose of describing particular examples only and is not intended to be limiting. As used herein, the singular forms “a”, “an” and “the” are intended to include the plural forms as well, unless the context clearly indicates otherwise.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined only in accordance with the following claims and their equivalents.

1. A method for electronically producing media content, comprising:
presenting, via a graphical user interface, a composition canvas area;
receiving, via one or more input devices, a location selection for each of one or more graphical elements, wherein each of the one or more graphical elements represents media content including any one of (i) a track, (ii) one or more instruments, or (iii) an additional user, and wherein the location selection identifies a location on the composition canvas area at which to overlay a respective one of the one or more graphical elements; and
producing at least a section of a digital composition based on the location of the one or more graphical elements on the composition canvas area.

2. The method of claim 1, wherein producing at least the section of the digital composition further comprises:
determining one or more parameter values for each of the one or more graphical elements based on the location of the one or more graphical elements; and
producing at least the section of the digital composition based at least in part on (i) the media content represented by each of the one or more graphical elements and (ii) the one or more parameter values.

3. The method of claim 1, further comprising:
receiving, via the one or more input devices, one or more parameter values associated with the one or more graphical elements, the one or more parameter values representing (i) a predetermined playing style, (ii) a timbre value corresponding to a predetermined style of music, (iii) a complexity value corresponding to a degree of complexity of at least the section of the digital composition, or (iv) any combination thereof; and
wherein producing at least the section of the digital composition includes:
producing at least the section of the digital composition based at least in part on (i) the media content represented by each of the one or more graphical elements and (ii) the one or more parameter values.

4. The method of claim 3, wherein the degree of complexity corresponds to any one of (i) a predefined range of chord complexity, (ii) a predefined range of melodic complexity, (iii) a predefined range of chord-melody tension, (iv) a predetermined range of chord progression novelty, (v) a predetermined range of chord bass melody, (vi) a degree of instrumentational variety, (vi) a combination thereof.

5. The method of claim 1, further comprising:
combining two or more composition canvas areas, thereby combining two or more sections of the digital composition;
receiving, via the one or more input devices, a selection of a predetermined effect from a plurality of predetermined effects; and
applying the predetermined effect to at least one of the two or more sections of the digital composition.

6. The method of claim 1, further comprising:
combining two or more composition canvas areas, thereby combining two or more sections of the digital composition;
receiving, via the one or more input devices, a selection of a transition content item from a plurality of transition content items; and
inserting the transition content item between two composition canvas areas of the two or more composition canvas areas.

7. The method of claim 1,
wherein receiving the location selection includes:
receiving, via the one or more input devices, a position modification instruction to move a first graphical element of the one or more graphical elements from a first location on the composition canvas area to a second location on the composition canvas area; and
wherein producing at least a section of the digital composition includes:
modifying the digital composition based on the position modification instruction.

8. The method of claim 7, wherein modifying at least the section of the digital composition based on the position modification, further includes modifying at least the section of the digital composition based on a positional relationship between the first graphical element and one or more other graphical elements on the composition canvas area.

9. The method of claim 1,
wherein receiving the location selection includes:
receiving, via the one or more input devices, a position modification instruction to move a first graphical element of the one or more graphical elements, wherein:
when the position of a first graphical element is moved along an X-axis of the composition canvas area, a first set of composition parameter values change, and
when the position of the first graphical element is moved along the Y-axis of the composition canvas area, a second set of composition parameter values change; and
wherein at least the section of the digital composition is produced, at least in part, based on one or more of the first set of composition parameter values or the second set of composition parameter values.

10. The method of claim 1, further comprising:
receiving, via the one or more input devices, a graphic element selection of a first graphical element from the one or more graphical elements on the composition canvas area, thereby causing a parameter prompt to be presented via the graphical user interface;
receiving, via the one or more input devices, a parameter modification instruction causing a parameter value associated with the first graphical element to be modified, thereby generating a modified parameter value; and
modifying at least the section of the digital composition based on the modified parameter value.

11. The method of claim 1, further comprising:
presenting, via the graphical user interface, a selectable toggle graphical element, which when selected causes graphical user interface to switch between presenting a digital audio workstation interface and the composition canvas.

12. The method of claim 1, further comprising:
before receiving the location selection, presenting via the graphical user interface, at least one of the one or more of the graphical elements on the composition canvas.

13. The method of claim 1, further comprising:
receiving, via the one or more input devices, a graphical element selection of at least one of the one or more graphical elements; and
in response to receiving the graphical element selection, overlaying the graphical elements on the composition canvas.

14. A system for electronically producing media content, comprising:
one or more processors, wherein the system is in communication with a graphical user interface and one or more input devices; and
memory storing one or more programs configured to be executed by the one or more processors the one or more programs including instructions for:
presenting, via a graphical user interface, a composition canvas area;
receiving, via one or more input devices, a location selection for each of one or more graphical elements, wherein each of the one or more graphical elements represents media content including any one of (i) a track, (ii) one or more instruments, or (iii) an additional user, and wherein the location selection identifies a location on the composition canvas area at which to overlay a respective one of the one or more graphical elements; and
producing at least a section of a digital composition based on the location of the one or more graphical elements on the composition canvas area.

15. The system of claim 14, wherein the one or more programs further includes instructions for producing at least the section of the digital composition further comprises:
determining one or more parameter values for each of the one or more graphical elements based on the location of the one or more graphical elements; and
producing at least the section of the digital composition based at least in part on (i) the media content represented by each of the one or more graphical elements and (ii) the one or more parameter values.

16. The system of claim 14, wherein the one or more programs further includes instructions for:
receiving, via the one or more input devices, one or more parameter values associated with the one or more graphical elements, the one or more parameter values representing (i) a predetermined playing style, (ii) a timbre value corresponding to a predetermined style of music, (iii) a complexity value corresponding to a degree of complexity of the digital composition, or (iv) any combination thereof; and
wherein producing at least the section of the digital composition includes:
producing at least the section of the digital composition based at least in part on (i) the media content represented by each of the one or more graphical elements and (ii) the one or more parameter values.

17. The system of claim 14,
wherein receiving the location selection includes:
receiving, via the one or more input devices, a position modification instruction to move a first graphical element of the one or more graphical elements from a first location on the composition canvas area to a second location on the composition canvas area; and
wherein producing at least a section of the digital composition includes:
modifying at least the section of the digital composition based on the position modification instruction.

18. The system of claim 17, wherein modifying at least the section of the digital composition based on the position modification, further includes modifying at least the section of the digital composition based on a positional relationship between the first graphical element and one or more other graphical elements on the composition canvas area.

19. The system of claim 14,
wherein receiving the location selection includes:
receiving, via the one or more input devices, a position modification instruction to move a first graphical element of the one or more graphical elements, wherein:
when the position of a first graphical element is moved along an X-axis of the composition canvas area, a first set of composition parameter values change, and
when the position of the first graphical element is moved along the Y-axis of the composition canvas area, a second set of composition parameter values change; and
wherein at least the section of the digital composition is produced, at least in part, based on one or more of the first set of composition parameter values or the second set of composition parameter values.

20. A non-transitory computer-readable storage medium storing one or more programs configured to be executed by one or more processors of a computer system that is in communication with a graphical user interface and one or more input devices, the one or more programs including instructions for:
presenting, via a graphical user interface, a composition canvas area;
receiving, via one or more input devices, a location selection for each of one or more graphical elements, wherein each of the one or more graphical elements represents media content including any one of (i) a track, (ii) one or more instruments, or (iii) an additional user, and wherein the location selection identifies a location on the composition canvas area at which to overlay a respective one of the one or more graphical elements; and
producing at least a section of a digital composition based on the location of the one or more graphical elements on the composition canvas area.
